(19) United States
(12) Patent Application Publication
(10) Pub. No.: US 2013/0121449 A1
(43) Pub. Date: May 16, 2013

(54) METHOD AND DEVICE FOR DIRECT NUCLEAR ENERGY CONVERSION IN ELECTRICITY IN FUSION AND TRANSMUTATION PROCESSES

(71) Applicant: Liviu Popa-Simil, Los Alamos, NM (US)

(72) Inventor: Liviu Popa-Simil, Los Alamos, NM (US)

(21) Appl. No.: 13/297,243

(22) Filed: Nov. 15, 2011

(51) Int. Cl. G21B 1/00

(52) U.S. Cl. 376/147; 376/149

(57) ABSTRACT

A method and device to generate electric energy on demand by fusion or transmutation nuclear reactions produced inside a super-capacitor that uses inter-atomic field's particularities obtained inside nano-structures, by using temperature, density and electric fields in order to modify nuclear entanglement and quantum non-localities particularities in order to control nuclear reaction rate of an inserted material, called nuclear fuel, facilitated by the nano-structure nuclear composition, called burner, that controls the non-local nuclear reaction.

Fusion or transmutation generated nuclear particles' energy is converted using a super-capacitor made of a micro-nano-hetero structure meta-material that loads from the nuclear energy and discharges by electric current.

The device contains the nuclear burner module that produces the nuclear particles surrounded by the direct nuclear energy conversion into electricity super-capacitor modules comprising several functional sub-modules, and the utilities that provide the nuclear fuel and byproducts management and process control systems.

### CROSS REFERENCE TO RELATED APPLICATIONS

This application is claiming no priority..

### BACKGROUND

The production of energy from nuclear reactions is a well established domain. There are known the fission and fusion applications as well the accelerator induced nuclear transmutations. As a new domain, it starts to develop the nuclear quantum entanglement and nonlocality theories based on experimental advances as a way to explain new phenomena. The present invention refers to a method of controlling the nuclear reaction rate in nano-cluster assemblies and a device to produce electric energy, using the kinematical properties of such reactions.

FIG. 1 shows an exemplary plot of the tunneling of the particle inside an oscillator confined inside a quantum-well like almost all the nucleus in the real matter lattices are. The tunneling equation is:

I(x,t)=I₀^{t}^{₀}e^{-λx}sin(ωt+φ) (Eq. 1) where

I(x,t) is the amplitude of the tunneling wave transmitted through the wall or barrier; as a function of distance and the propagation time, in the idea of a linear consistent space inside the 1 nm radius around the nucleus. I₀ represents the amplitude of the wave probability density transmitted at the wall boundary, at the time t0 when the particle is at rest on the energy potential barrier, and we trend to believe that it is equal with 1. Tunneling formula tells us that there is an exponential decay with the radius, captured inside the exponential term and a wave behavior captured inside the sinusoidal term.

In fact a particle bouncing on a quantum wall transmitting an evanescent wave through it—also similar to tunneling. Modern quantum mechanics considers a non-locality or a phenomenon called entanglement. This comes in contradiction with a common sense principle that an object occupies a single position at a certain time moment. In this case, the object is everywhere, with different probabilities of occurrence, and only an outside intervention—as the presence of another particle determines the quantum object to take a stand, and show up in a location or another, often placed in different space-time cones, that requires super -light speeds to explain the propagation. It seems that there is NO Propagation, but a fold of the space, that makes the object be in many position at once and show-up in at least one.

When the nucleus reflects against the quantum/potential well an entanglement or tunneling wave propagates around, but not as a spherical wave. We trend to believe that it behaves like a soliton having a displacement in the same direction with the nucleus oscillation vector. If the nucleus will be alone with a homogenous structure inside the wave might be supposed as being spherical, only for didactical purposes, and easiness of the mathematical approach.

The wave speed and propagation is supposed of being those of the local speed of light, but in the absence of uniform matter that to give an average refraction index, the electromagnetic stress tensor regulates the local propagation properties.

The problem becomes more complex because almost all the nuclei above Hydrogen have a complex structure generically formed of nucleons (protons and neutrons), which is in fact is a soup of quarks boiling inside the space domain we consider the actual nucleus, and redistributing in order to give the minimum energy, or maximum binding energy sub-structures. That will make the entanglement wave be heterogeneous, and having time and space dependent proprieties.

The entanglement is a very delicate concept—as we know from high school and regular physics that an object can NOT be in the same time in two different spaces, when we talk about entanglement this basic concept ceases to be true, and the space gets “short-circuited” in such a manner that points outside the Minkovski cones behave that being the same space. Going deeper in String theory and QCD this effect finds a reasonable explanation, that is hard to find in classical physics.

The important part one have to understand is that at different time moments some specific points in the space surrounding an atomic nucleus behave like being part of the same space of the nucleus, or the nucleus is appearing in those points for a period of time and probability depending on a modified tunneling probability that is usually considered an exponential decay. That is not quite true because the exponential law is modified by the atomic and electronic structure of the space surrounding the nucleus of reference.

FIG. 1 shows how a tunneling wave is generated and propagates from a quantum particle reflecting against a rectangular potential wall, decaying with the distance from the wall exponentially. As each particle has an associated a wave, simplistically speaking, our wave will not be a smooth exponential, but an oscillatory function following an exponential decay of the amplitude. But being a spherical function it is supposed to be more like a Bessel function than a sin function. That's another very simplistic approach.

I believe that the associated function of entanglement may be considered at the quark level and an interference of Bessel functions may be obtained around the nucleus in the 3D space having a temporal window or occurrence assigned.

The presence of another space—time-energy formation—for example another nucleus—may make the nucleus to “take a stand” in quantum terms and materialize all in that point of the 4D space—being what we usually call “tunneling effect” similar to an octopus that if it likes the fish and needs it to stabilize its bio-processes, it may decide to move a tentacle and catch it, or in the other cases it may remain invisible to the fish.

FIG. 1 shows in the right side a bumpy wave, that decays with the distance from a spherical multi-component entity, oscillating inside its potential walls. It has to be stated the time dimension, and the asymmetry due to momentary particularities of the oscillation reflection on the quantum potential well. All these issues are under debate and it is what the theoreticians of the future will fix in much larger detail. For us in order to understand the basic process we have to admit that the nucleus can manifest as present in a plurality of locations of the space, outside Minkowski cones. As anticipation—if the nucleus is there and there and accidentally overlaps over another nucleus entangled spaces the two nuclei are like being in the same space=fusion. This, non-local fusion will be further detailed.

In FIG. 1 the particle 103, represented by its density of probability figuring mainly a 2D Gaussian is located in the left half of the image 101 that has the axes 102 and 104. The potential barrier is set at the 50% on horizontal axes 104, oscillating parallel with it. The line 105 represents the direction of the potential soliton, emitted by the particle, that has an exponential decay of the probability density amplitude 107. The oscillatory feature embedded in the wave generates puddles of higher density of probability 106 where the initial particle 103 features, including its spins 108 are identically reproduced similar to particle being virtual teleported in those positions.

In some of the zones the space behaves “strange”—and creates an entanglement—the principle that an object cannot be in two places in the same time is not TRUE—the particle is there but does not take a stand. x=ct rule of electromagnetic action does not apply; t=0; x=0 or undefined.

FIG. 2 shows an image representing an nuclear entanglement constructive interference produced by two adjacent atoms. The two atoms spaced apart have some synchronized oscillating modes transmitting the tunneling wave one towards the other. In some specific points the density of probability of tunneling gets significant values, and the coincidence that a particle being present in that point makes it simultaneously being present inside the nucleus structure. More the overlapping of these two ghost places brings the atoms in near communion phase, opening some nuclear reaction channels, most usually producing the transmutation, where the isotopic concentration of the structure migrates towards stability configurations.

When the nucleus 201 respectively 202 is colliding against the potential walls 221 and respectively 220 the entanglement wave is transmitted through the wall propagating along the direction of oscillation of the nucleus modified by the refraction in the wall domain. It decays exponentially as the density of occurrence probability 215, respectively 216 shows, waving a wave super modulation imposed 217 and 218 that makes that certain places to be less probable than others. These waves pass like solitons.

When these waves are coming closer an interference with another wave creates interference steady zones of probability. The mediated entanglement becomes stable and the probability that the two nuclei 2003, 2004 to be caught in a better exchange mood increases.

The overlapping of the two tunneling points 225 in the same moment of time makes the two nuclei being present one into another as heavy ion fusion as in heavy ion-heavy-ion accelerator induced collisions, with the difference that the atoms are at very low energy and still being part of a material lattice. The probability that they to remain together and generate a super-heavy nucleus is infinitesimally small, being driven by the binding nuclear energy and nuclear stability, and because the conservation laws imposes to end up with at least two bodies. In these cases the particles fell apart in the initial state, or some nuclear transmutation by fragmentation of one nucleus and adding to the other nucleus being possible, but in the frequent case of using Fe zone nuclei the transmutation probability is very small, being driven by specific isotopic configurations and the synergy of the conservation principles.

FIG. 2 shows the case of two coupled atoms 203 and 204 oscillating one into another with extraordinarily high amplitudes 207 and 208 of 50% of the bound length, that is usually of 1-2 A (angstrom) or 100-200 pm (pico (10⁻¹²)-meters) only for explanation purposes. In the case of C-sp² bound orbital length this is of about 133-145 pm while the nucleus dimension is of about 5.6 fm (femto (10⁻¹⁵)-meters). The thermal vibration amplitude is usually under 1% of the bound length, and nothing might be seen on the figure if an accurate scale representation have been made.

The potential well walls 221 and 220 are also a mechanical type of visualization. In reality it does not seem to exist such a thing, but a domain of space where the probability or likelihood of existence of the particle is greater, being very unclear how the particle is moving in that domain. The oscillation eigen modes and its amplitudes 207 and 2008 matters, because the propagation of the entanglement soliton is made in function of that direction 213, 214. Along this direction the probability of tunneling decays and is wave modulated by sin^{e} function. When the direction are near and a synchronized oscillation is obtained the shift vector 219 is small that makes the two solitons emitted by the two atoms to interfere and their domains of likelihood 211, 212 to partially overlap 225. In this point the partial fusion occurs and a few quark exchange is possible.

The cones 201, 202 separated by the distance Δx₁>cΔt₁, where c is the speed of light in vacuum, and 205, 205 separated by the distance Δx₂>cΔt₂ represents Minkowski space-time cones, and represents entanglement points, that have the particularity that the interaction or transmission of a state is propagated with super-light speeds, or through short-cuts in the space fabric.

When the different orientation vibration amplitude 207 and 208 grows, simply due to electronic contribution or other lattice modes, the directions 213 and 214 become more divergent and the distance between them 219 growth, and the overlapping density function, or in other words the interaction cross-section decreases. This process gives us a possibility of controlling the interaction rate, by controlling the eigen-modes of vibration amplitudes A₂₀₇/A₂₂₃ and A₂₀₈/A₂₂₄ and the phase shift φ₂₀₃-φ₂₀₄ supposing that the oscillation frequencies driven by ω̅₂₀₃= ω̅₂₀₄ are equal. The likelihood probabilities 217, and 218 are not decaying following the exponential curves 215 and 216. These aspects are explained in string theory, but for the purpose of our device this level is may be enough, to understand this reaction and how its means of control are developed driving to an embodiment of this invention.

FIG. 3A is a short presentation of the nuclear binding energy 301, that represents the basis of the nuclear reactions, in the light of the fact that all the nuclear matter trend to enter in such combinations that to maximize their binding energy.

The mass defect equivalent energy is what is released and is our reward of facilitation these nuclear reactions:

$$\begin{matrix}{E}_{B} = ( {ZM}_{H} + {NM}_{N} - {}_{Z}^{A} M ) {c}^{2} \to {c}^{2} \\ = \frac{0.9315 GeV}{u}\end{matrix} \qquad ( Eq2 )$$

where Z is the atomic number, or number of electrons or protons in the nucleus, N is the number of neutrons, and M is the mass of respectively Hydrogen nucleus, neutron and the bound isotope as illustrated in FIG. 3 A upper side 303-304.

The binding energy curve 302 has a maximum of about 8.8 MeV/nucleon for iron, ⁵⁶Fe, and lower energy for smaller nuclei 303 or bigger nuclei 305.

The transition from a nucleus to another is called transmutation, while the transition from very small nuclei to bigger ones is called fusion, while the transition from a bigger nucleus 305, like ²³⁵U to smaller ones is called fission.

FIG. 3B is further of one more detail needed for one skilled in the art to understand the basis of this invention and to easily handle with the dimensions and knowledge used.

An atom of H is shown 320 where the orbital structure and dimensions are detailed. The quark structure of the proton is also detailed.

The Deuterium atom, 321, also called heavy hydrogen is briefly presented, and the structure of tritium, 324 near by.

The helium nucleus 322 dimensions and total energy is given, and as well the Lithium-7 323 is shown.

FIG. 4A shows the relationship between the nuclear structure 401 and binding and excitation energies, 402 as well the multi-dimensionality of the atomic to nuclear structure 403.

As it was shown in the atomic structure 403 has the dimensions about 100 pm, while the nucleus inside is in the range of 10 fm, being composed of nucleons (protons and neutrons) with the dimension of 1 fm, that are formed of quarks with the size in 1 am (ato-meter), same as electrons.

The nucleons are combining forming the nuclei with different masses, but only a narrow combination of protons, versus neutrons is stable 402 and makes various isomer nuclear surface shapes shown in 401. The shape is related to nuclear stability and to the tendency of generating nuclear reactions.

FIG. 4B Electron capture is a process in which a proton-rich nuclide absorbs an inner atomic electron (changing a nuclear proton to a neutron) and simultaneously emits a neutrino. Various photon emissions follow, in order to allow the energy of the atom to fall to the ground state of the new nuclide.

Electron capture is the primary decay mode for isotopes with a relative superabundance of protons in the nucleus, but with insufficient energy difference between the isotope and its prospective daughter (with one less positive charge) for the nuclide to decay by emitting a positron. Electron capture also exists as a viable decay mode for radioactive isotopes with insufficient energy to decay by positron emission, and it competes with positron emission. It is sometimes called inverse beta decay, though this term can also refer to the capture of a neutrino through a similar process.

If the energy difference between the parent atom and the daughter atom is less than 1.022 MeV, positron emission is forbidden because not enough decay energy is available to allow it, and thus electron capture is the sole decay mode. For example, rubidium-83 (37 protons, 46 neutrons) will decay to krypton-83 (36 protons, 47 neutrons) solely by electron capture (the energy difference, or decay energy, is about 0.9 MeV).

FIG. 4B shows a schematic diagram of a nucleus 411 initiating a k shell electron 412 capture. K electrons seem to be more preferred for capture than 1 electron 413 or M electrons 412.

After the capture took place and the electron simply disappears from its position on the orbital 412 leaving an empty place similar to an excited atom, carrying the extraction energy, the atom is preparing for a readjustment and transitions 420 in the final stage, before stability.

FIG. 4C shows a the movements of the atom 421 to transition to stability, by emitting an Xₖₘ ray 425 when the M electron 424 stepping down and fulfills the k orbital 422. The M electron 423 may be also affected by the orbital tremor and be emitted as an Auger Electron, leaving the atom still excited when this process accompanies the 1 k transition.

Note that a free proton cannot normally be changed to a free neutron by this process: The proton and neutron must be part of a larger nucleus. In the process of electron capture, one of the orbital electrons, usually from the K or L electron shell (K-electron capture, also K-capture, or L-electron capture, L-capture), is captured by a proton in the nucleus, forming a neutron and a neutrino.

p+e⁻→n+v^{e}

Since the proton is changed to a neutron in electron capture, the number of neutrons increases by 1, the number of protons decreases by 1, and the atomic mass number remains unchanged. By changing the number of protons, electron capture transforms the nuclide into a new element. The atom, although still neutral in charge, now exists in an energetically excited state with the inner shell missing an electron. While transiting to the ground state, the atom will emit an X-ray photon (a type of electromagnetic radiation) and/or Auger electrons, or both. Often the nucleus exists in an excited state as well, and emits a gamma ray in order to reach the ground state energy of the new nuclide just formed.

Examples of such nuclear reactions are:

²⁶₁₃Al+e⁻→²⁶₁₂Mg+v^{e}

⁵⁹₂₈Ni+e⁻→⁵⁹₂₇Co+v^{e}

⁴⁰₁₉K+e⁻→⁴⁰₁₈Ar+v^{e}

Note that it is one of the initial atom's own electrons that is captured, not a new, incoming electron, as might be suggested by the way the above reactions are written. Radioactive isotopes that decay by pure electron capture can, in theory, be inhibited from radioactive decay if they are fully ionized (“stripped” is sometimes used to describe such ions). It is hypothesized that such elements, if formed by the r-process in exploding supernovae, are ejected fully ionized and so do not undergo radioactive decay as long as they do not encounter electrons in outer space. Anomalies in elemental distributions are thought to be partly a result of this effect on electron capture.

In the light of what was presented above the reaction chain is normally able to extend several hundreds of fm, over the size of a chemical bound length. This manifestation resembles an octopus that selectively chooses the fish it likes and extends its tentacles to catch it. In the case of particles the kinetic energy is the selection parameter. That is what was previously described as nuclear entanglement.

Chemical bonds can also affect the rate of electron capture to a small degree (in general, less than 1%) depending on the proximity of electrons to the nucleus. For example in ⁷Be, a difference of 0.9% has been observed between half-lives in metallic and insulating environments. This relatively large effect is due to the fact that beryllium is a small atom whose valence electrons are close to the nucleus.

Around the elements in the middle of the periodic table, isotopes that are lighter than stable isotopes of the same element tend to decay through electron capture, while isotopes heavier than the stable ones decay by electron emission.

Some common radioisotopes that decay by electron capture include:

| Class 1 | Class 2 | Class 3 | Class 4 |
|---|---|---|---|
| ⁷Be T_{1/2} = 53.28 d; | ⁵⁶Ni T_{1/2} = 6.10 d;, | ⁴⁹V T_{1/2} = 337 d | ⁴⁴Ti T_{1/2} = 52 y |
| ³⁷Ar T_{1/2} = 35.0 d; | ⁶⁷Ga T_{1/2} = 3.260 d | ⁵⁷Co T_{1/2} = 271.8 d | ⁴¹Ca T_{1/2} = 1.03 10⁵ y |
| ⁵¹Cr T_{1/2} = 27.7 d | ⁷²Se T_{1/2} = 8.5 d | ⁶⁸Ge T_{1/2} = 270.8 d; | ⁵³Mn T_{1/2} = 3.7 10⁶ y |

Are observed that are plotting in some families with the feature of reducing the lifetime with the growth of the atomic number. It seems that they prefer some electrons, from s orbital with spin up or s orbital with spin down, and the probability of nuclear entanglements are different, as a function of these selection parameters, but the probability is increasing with the decrease of the electron orbital radius, or distance to the nucleus.

Another interesting case is that of the giant resonance cross sections. In nuclear and particle physics, the concept of a cross section is used to express the likelihood of interaction between particles.

When particles in a beam are thrown against a foil made of a certain substance, the cross section σ is a hypothetical area measure around the target particles of the substance (usually its atoms) that represents a surface. If a particle of the beam crosses this surface, there will be some kind of interaction.

A barn (symbol b) is a unit of area. Originally used in nuclear physics for expressing the cross sectional area of nuclei and nuclear reactions, today it is used in all fields of high energy physics to express the cross sections of any scattering process. A barn is defined as 10^{-∞}m² (100 fm²) and is approximately the cross sectional area of a uranium nucleus.

¹³⁵Xe, with its extremely high absorption cross-section of 2.65×10⁶ barns is “used up” quickly upon creation, transmuting into 136Xe, which is a stable isotope that means a diameter of about 20 fm, which is 4 times larger than the nucleus itself In the case of giant nuclear resonance, the direct mechanical transpositions are even more intricate. In this case suddenly one has an atom that has a cross section shadowing several atoms of the lattice. This manifestation, in spite it is contained inside quantum mechanics is not directly explained, and only some calculation receipts are provided.

Graphically the nucleus is seen with a size of 20% of that of the atom, instead its size of a 0.1%, looking-like the atom in FIG. B, 411.

FIG. 5 shows a schematic cross sectional diagram of a nano-cluster with cubic structure 501, similar to the Pd metal nano-clusters. In a simplified similar structure the atoms 502, are placed in the corners, and under phonon oscillation they exhibit a large variety of eigen-modes. In this case showing the stationary waves of tunneling—entanglement probability density function 503 turns to be very complicated involving a 4D space.

For simplicity we consider only 4 atoms 502 in a plane creating a square structure. It is not clear if the tunneling probability function 503 is the same with the entanglement probability function or the first propagation in the linear space prepares the space for the generation of the entanglement function that behaves like a short-circuit of the linear 3D space from another dimensions of the subspace. This explanation is important from the theoretical point of view of better understanding the matter, energy and space but from our application point of view the presence of this phenomenon is what matters.

There are some oscillation eigen-modes that make the entanglement wave propagate inside and overlap giving stationary waves maximum 504, creating an unlocal-compound-nucleus, where the quarks are put together as in fusion

In a Pd, Ni or Pt lattice on a plane there are 4 atoms 502 oscillating under temperature excitation inside the force field of the chemical bound.

The symmetry may create more stationary eigen states 505 distributed inside the atomic 502 cell volume on symmetry axes.

The non locality, possibly due to stationary waves, makes the spaces interfere, long enough in order that a nuclear reaction to be induced. The non-locality waves or tunneling waves are a special manifestation of the space-time-matter realm and is also described as entanglement. The notion of entanglement is mainly used to show that a particle may be in various different places of the 4-D (Minkowski) space, simultaneously, with the probability that the particle to take a stand and show up in a certain location is depending on other called paricle's external parameters, or environment.

The effect of non-locality is also described by Heinsenberg's uncertainty principle, but in fact it may be due to the open-space entanglement connecting the dimensions E and t and r and p as being dependent parameters, generated by the same entity.

In fact this entanglement may be explained that the mass-energy is a space effect, and creates special space structures, that hold matter, and gets what we call matter properties, through the sub-space. The multi-dimensional space of the string theory makes possible to explain these effects, at least in part, by the concept of multidimensional universe.

In fact the tunneling effect is not clear if it is an entanglement effect or a propagation effect, in which a space-shape phantom that travels outside the particle classical borders gets materialized, having a finite traveling speed, or an entanglement effect with a latency time, making the particle appear through another “hole” in the space fabric with the same properties as the initial particle or even better adapted to the new environment.

If this is the case, the particle is present in a plurality of points of the space all the time, and depending the environment's features it TAKES A STAND in at least one of them—as staying in the classical point or materializing in a new point of the space, and that is what we used to call tunneling.

The presence of a particle in a “classical” point of space we call nucleus or corpuscle, with defined coordinates and parameters (in the limit of Heinsenberg's principle), but its presence modifies the wrapping of the multi-dimensional space and the interaction with another particle may take place in some of the cases almost instantaneous, the particles knowing about each other presence by the deformation of space and subspace, without a direct hard interaction (as in the quantum basic concept of a measurement of a quantum state) to be needed.

In the case when another particle and its phantom/entanglement domains are overlapping they are practically together in the same location in the subspace interacting, in spite in our space appears as being in different locations—and they are. In this way, it is explained the nuclear cross section with a clear manifestation in the case of nuclear super-resonances.

As it was previously shown the dimensions of an atomic bond, or the distance between consecutive nuclei in a material is about 100 pm, while the dimensions of the nucleus itself calculated or measured outside resonance is of few fm, by a factor of 10,000 smaller. The thermal oscillation amplitudes is of few pm.

In the case of ¹³⁵I the thermal neutrons absorption cross section is of about 3.10⁶ barns that gives a cross section area of 3.10⁻²² m²=(1.71.10⁻¹¹)² m² and an equivalent radius of about 0.01 nm. This covers more than 0.1 atoms on one linear direction, and about 1 atoms in volume. In the light of the classical mechanics it is impossible to visualize this aspect, but only if we understand the new concepts of entanglement this aspect makes sense. The Iodine atom is there, from time to time overlaps the lattice atoms space entanglement, but the energy gain is small in order to activate any entanglement driven reaction. From time to time a spontaneous fission occurs, as the excess of n is transferred to lattice U nuclei, that fissions the nucleus, with some significant energy gain. In order to have a more visual image, of what is statistically described by differential cross section, is the fact that ¹³⁵I and ²³⁵U are placed in the lattice position competing for neutrons, as a bunch of octopuses are competing for fish, and only is the fish they like, they make the effort to move the tentacles, take a stand and catch that fish. The thermal vibration modifies the cross section, phenomenon called nuclear Doppler effect.

The effect of generating nuclear reactions by entanglement is working in the case of fusion and transmutation that have been observed in electrolysis experiments. The modification of electrodes isotopic composition that has been also reported is possible only by transmutation, and over the time the theoretical understanding have been developed, and now these phenomena have better explanations.

FIG. 6—shows radiation, nuclear particle energy deposition in matter with exemplification for 100 MeV 140 Cs in UO₂ as being a typical case of fission product, as base of further developments.

It shows the Energy loss versus depth values 600 of the incident radiation interacting with matter that slows down mainly by the interaction between the moving particle and electron structures surrounding the atoms.

Chart's ordinate giving particle Energy Loss in (eV/Angstrom) for 5 MeV alpha in U 601, chart's abscise giving the Target Depth in (micrometers) 602.

During the interaction the radiation dislocates the electrons by direct electro-dynamic field collision generating high-energy knock-on electrons, showed as the Ionization curve on the chart 603.

These electrons also called delta-electrons collides with other electrons sharing the energy until it becomes small at the phonon energy level and in this moment the electrons are returning in the initial position under the electric field of polarization the structures making a loop trajectory, and transferring all their energy into phonons.

A part of the collision energy is transferred to X-ray emission by atomic level excitation that travels micron distances until resonantly is absorbed generating electron showers. If the delta electrons were conserving the initial impulse the electromagnetic X-ray energy in almost omni-directional contributing to energy spread.

Towards the end of the range the nuclear collision interactions between the stopping radiation particle and lattice nuclei is intensifying and this is the domain of so called radiation damage based on nuclear dislocations, represented on chart as the energy loss in recoil creation 604.

FIG. 9 shows that a ⁴He atom being implanted in an uranium carbide lattice with about 3 MeV similar to the case of fission products is traveling less than 10 microns stopping range being of about 8.2 microns with a straggling of +/−1 micron, as done using the Bethe-Bloch formula embedded in SRIM code.

### SUMMARY

According to the main embodiment, a method to produce nuclear reactions of fusion and transmutation in nano-structures and to make a device for producing electricity using the energy released by the nuclear reactions generated in the nano-structure, at adjustable power rate.

The method relies on the use of inter-atomic field particularities obtained inside the nano-structures by using the temperature, density and electric fields in order to modify the nuclear entanglement or quantum non-local nuclear cross-section in order to control the nuclear reaction rate of an inserted material, generically called nuclear fuel, into a nano-structured material with specific nuclear composition in order to facilitate the non-local nuclear reaction of the fuel, generically called burner.

The generated nuclear particles energy is converted using an assembly of a super-capacitor made of a micro-nano-hetero structure that loads from the nuclear energy and discharges by electric current.

According to another embodiment, the method is applied to knock-on electrons produced from stopping the moving entities resulted from the nuclear reaction drives to the design of a device for converting fusion energy into electrical energy that includes: a burner compartment where nuclear fuel is “burned” for generating fusion products by nuclear reactions; that are stopped in a plurality of direct conversion units stacked on the burner's surfaces, each CIci unit including a first conductive layer “C”, a first insulating layer “I”, a lower than the first conductive layer electron density layer “c”, and a second insulating layer “i”; and an electrical circuit coupled to the conductive layers and operative to harvest electrical energy. The fission products generate electron showers in the first layer that may contain nuclear fuel also while the low electron density layer absorbs the electron showers.

According to yet another embodiment, the method is applied to knock-on electrons produced from stopping the moving entities resulted from the nuclear reaction drives to the design of a tile for converting particle and radiation energy into electrical energy made of a morph of the CIci layers connected in series and parallel, that become a nano-clustered structure made of conductive nano-beads inserted into a dielectric or semiconductor material called meta-material, that converts the knock-on showers energy into electricity.

Applications are in nuclear fusion reactors, direct conversion of nuclear energy into electricity producing adjustable fusion battery structures. The electricity generator device uses repetitive nano-hetero-structure generically that may be also made of loaded nanotubes or coated nano-wires that behaves similar to the “CIci” structure described above.

The device contains the nuclear burner module in center that produces the nuclear particles surrounded by the direct nuclear energy conversion into electricity super-capacitor module that is formed of several functional sub-modules, and the utilities that provides the nuclear fuel and byproducts management and the process control systems.

The main application is to generate electric energy on demand by fusion nuclear reactions. The resulted devices are structural and dimensional varieties of method's application in specific configurations.

### BRIEF DESCRIPTION OF THE DRAWINGS

FIG. 1 shows the tunneling wave propagation outside the potential wall

FIG. 2 shows an image representing our understanding on nuclear entanglement created by the interference of two tunneling waves

FIG. 3A makes a short presentation of the nuclear binding energy, and gives a chart representing the binding energy dependence on atomic mass

FIG. 3B presents in more details the main light elements used as “nuclear fuel” and their relationship with the nuclear binding energy

FIG. 4A shows the relationship between the nuclear structure and binding and excitation energies, as well the multi-dimensionality of the atomic to nuclear structure

FIG. 4B shows the electron capture process inside a generic atom

FIG. 4C shows the relaxation of the atomic layers after the electron capture by its nucleus

FIG. 5 shows a schematic cross section through a Pd nano-cluster showing an artistic view of the entanglement points generated by a planar 4 atom eigen-mode tunneling wave interference.

FIG. 6—Nucleus Binding energy as function of atomic mass

FIG. 7 The Platinum family and Deuterium

FIG. 8 Palladium Deuterium atomic assembly and nuclear entanglement

FIG. 9 Helium Power deposition in UC

FIG. 10 5 MeV alpha particle power deposition into an alternate multi-layer structure

FIG. 11A A 5 MeV alpha particle crossing a “CIci” element

FIG. 11B Schematic diagram of the power deposition process

FIG. 12 Normalized range power deposition by ionization in various materials of a 5 MeV alpha particle, for material classification

FIG. 13 Knock-on electron e-Casino simulation

FIG. 14 e-Casino simulation for knock-on electron stopping density

FIG. 15 Material thickness optimization for knock-on electron collection maximization

FIG. 16 Example of a dimensional calculation of an energy direct conversion element optimized for power deposition of the moving particle.

FIG. 17A Schematic diagram of a single “CIci” elemental cell

FIG. 17B Schematic diagram of a modulus made of a plurality of “CIci” elemental cells to form a Direct Nuclear Energy conversion device.

FIG. 18A Serial connections in a stack of 3 “CIci” elemental cells.

FIG. 18B Cross sectional view in a stack of 2 “CIci” elemental cells

FIG. 18C The morph from the serial connection to bi-material

FIG. 18D The morph from bi-material nano-layers to nano-beads

FIG. 19 The bi-material nano-beaded direct energy conversion module

FIG. 20 The test circuit for a nano-beaded direct energy conversion module

FIG. 21 Nano-structure (loaded nano-wire or coated nano-tube) direct energy conversion module

FIG. 22A Nano-structure assisted fusion initiation measurement device in active position

FIG. 22B Nano-structure assisted fusion initiation measurement device in passive position

FIG. 23A Nano-structure assisted fusion schematic structure

FIG. 23B Transverse view of 22 MeV alpha particles stopping in 1 atm Deuterium gas and Silicon target trajectories simulation

FIG. 23C Lateral view of 22 MeV alpha particles stopping in 1 atm Deuterium gas and Silicon target trajectories simulation

FIG. 23D Ionization power deposition of 22 MeV alpha particles stopping in 1 atm Deuterium gas and Silicon target simulation

FIG. 23E Lateral view of 0.3 MeV recoiled Paladium stopping in palladium substrate trajectories simulation

FIG. 23E Transverse view of 0.3 MeV recoiled Paladium stopping in palladium substrate trajectories simulation

FIG. 23F Ionization power deposition of 0.3 MeV recoiled Palladium stopping in palladium substrate simulation

FIG. 24A Lateral view of 22 MeV alpha particles stopping in 1 atm 11 mm thick Deuterium gas and Silicon target trajectories simulation

FIG. 24B Ion ranges of 22 MeV alpha particles stopping in 1 atm 11 mm Deuterium gas and Silicon target simulation

FIG. 24C Ionization power deposition of 22 MeV alpha particles stopping in 1 atm, 11 mm thick Deuterium gas and Silicon target simulation

FIG. 24D Nuclear recoils power deposition of 22 MeV alpha particles stopping in 1 atm 11 mm thick Deuterium gas and Silicon target simulation

FIG. 25 Block diagram of the nano-structure induced fusion direct electric energy generator.

FIG. 26 Detailed functional diagram of the nano-structure induced fusion direct electric energy generator.

FIG. 27 Detailed block diagram of the nano-structure induced fusion direct electric energy generator burner control system.

FIG. 28 Detailed block diagram of the nano-structure burner induced fusion with direct electric energy generator modules embedded and blanketed by fusion product and fusion neutron energy harvesting modules.

FIG. 29 Functional block diagram of the fusion direct electric energy generator system containing the active zones harvesting the energy of recoils and transmutation byproduct interlaced into passive zones harvesting the energy of the fusion byproduct.

FIG. 30 The section view through a hexagonal nano-beaded direct energy conversion structure

### DETAILED DESCRIPTION

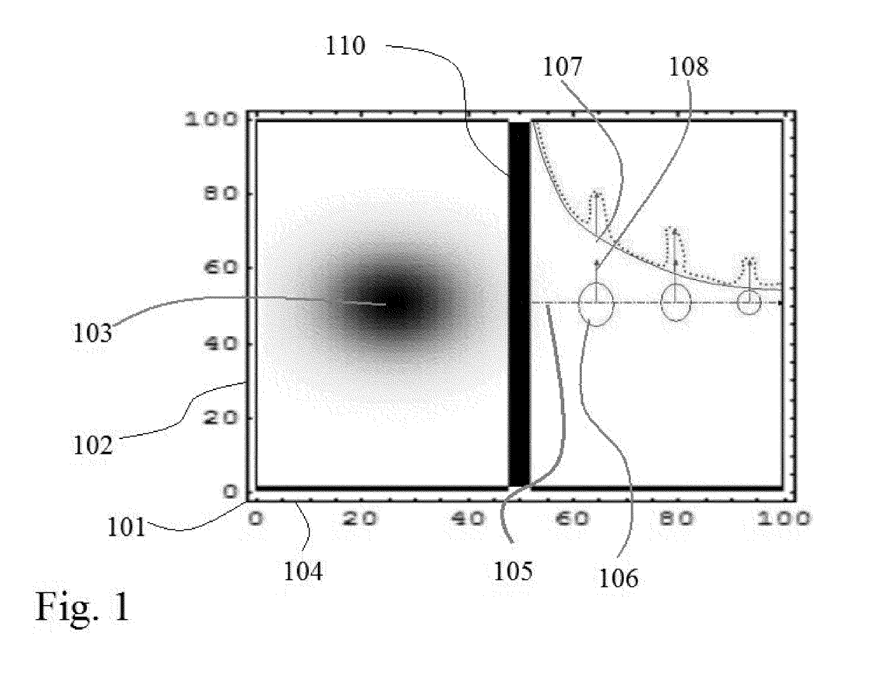

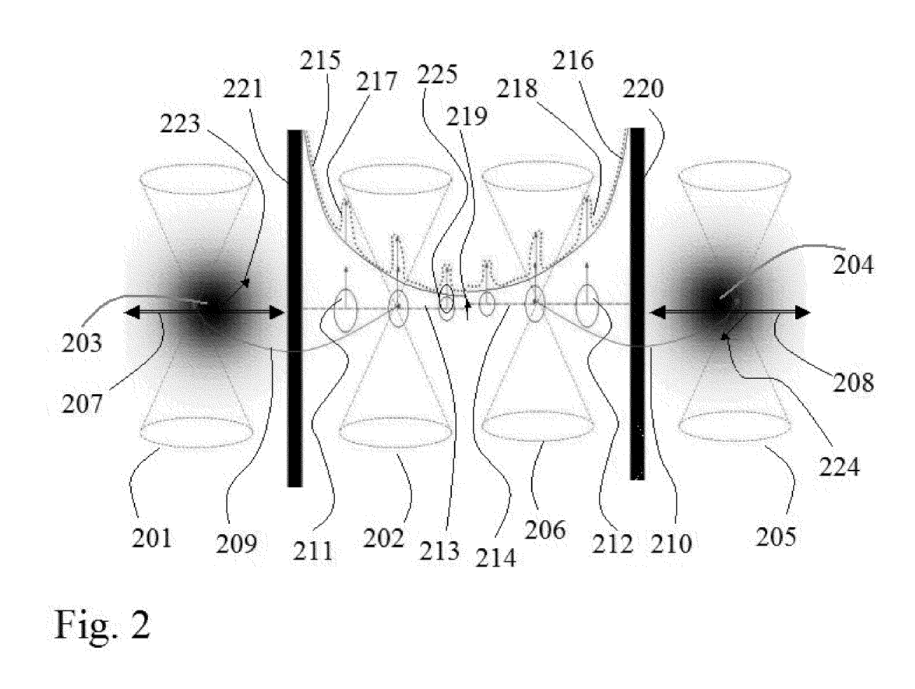

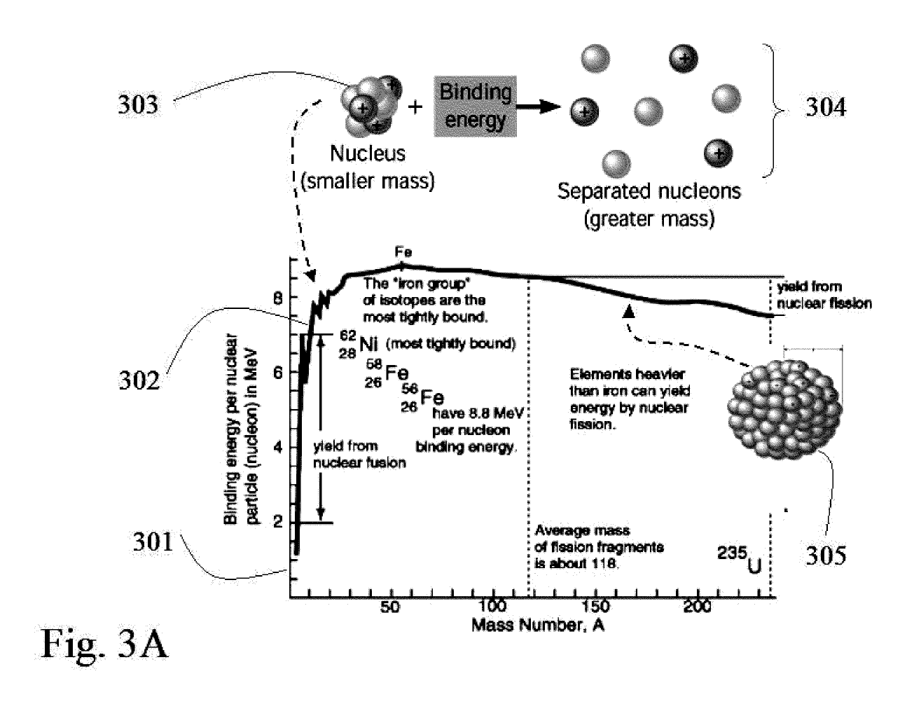

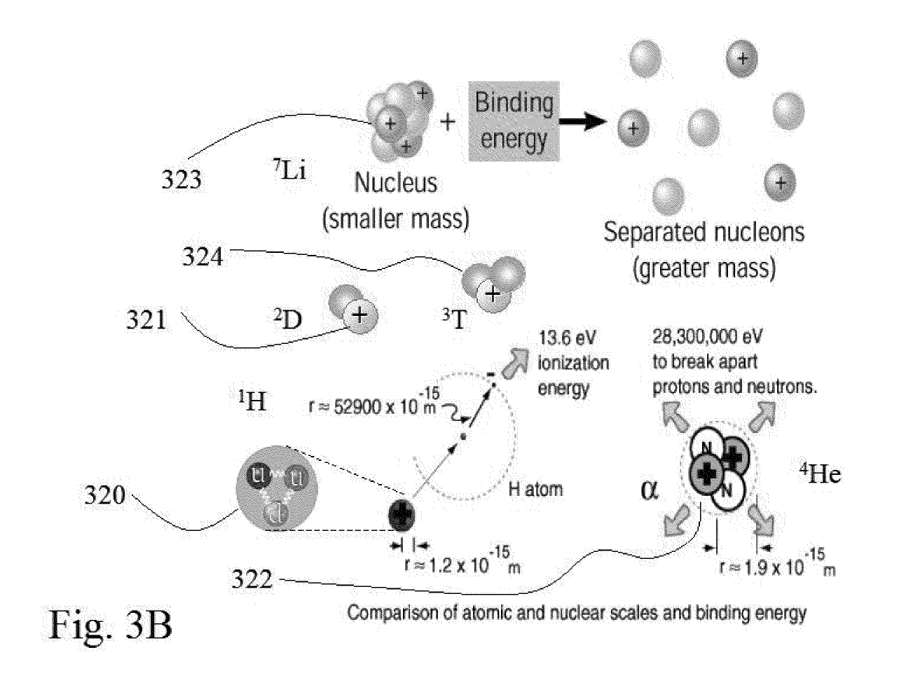

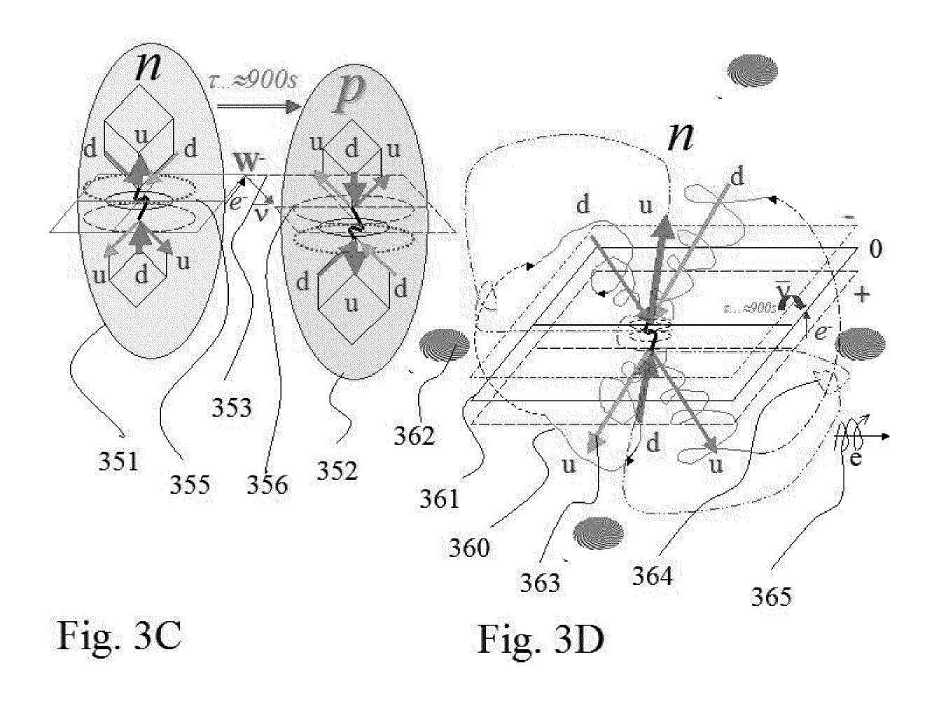

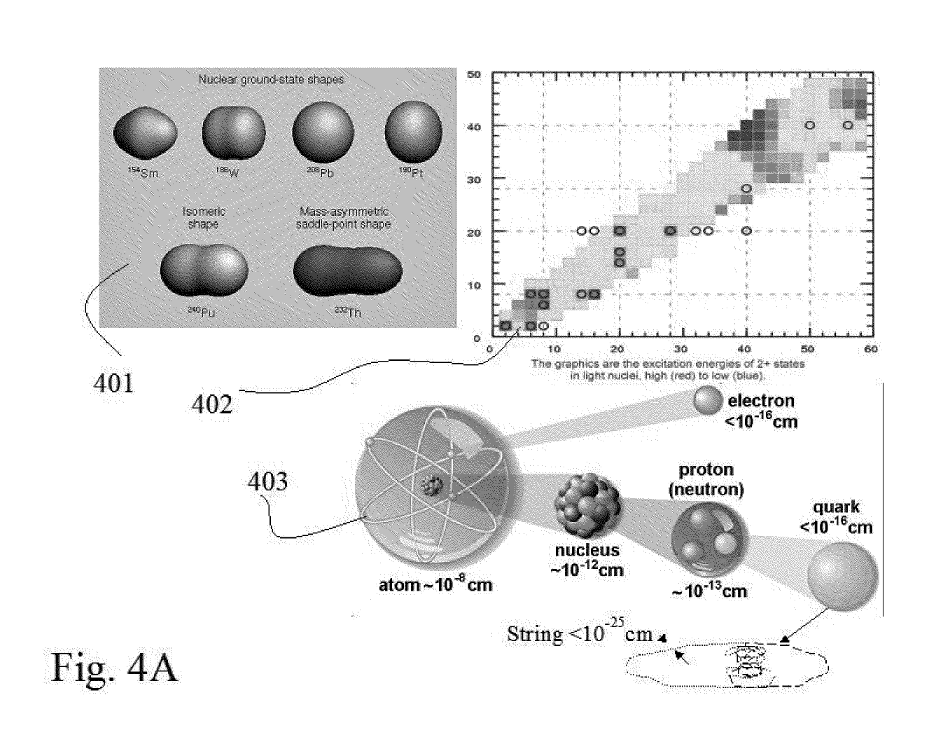

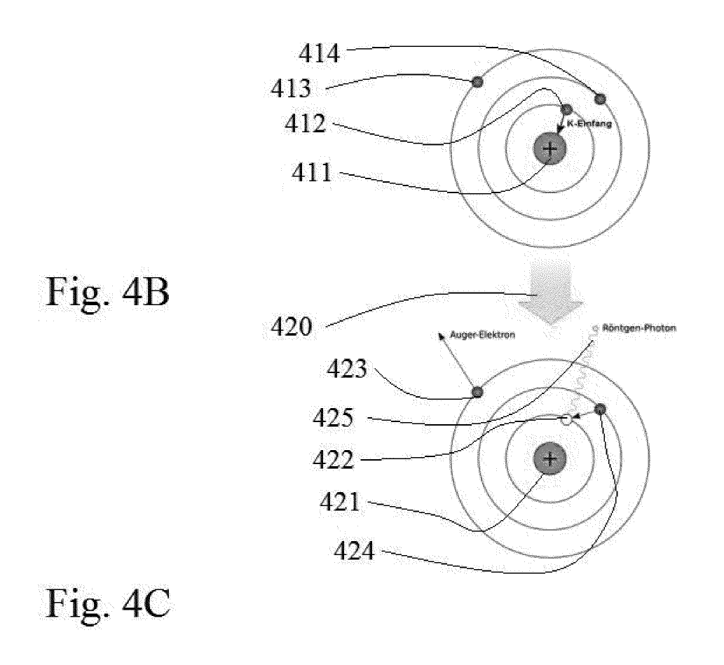

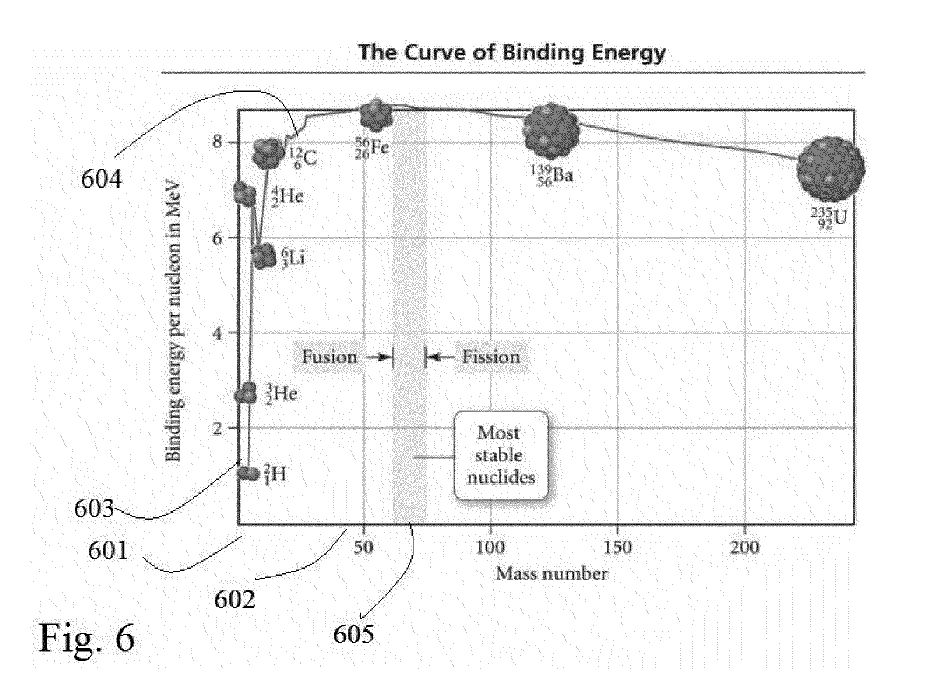

The understanding of the fundamental physics behind these processes given in FIGS. 1-9 representing the operation basis of the process we intend to control in order to build a compact electricity source powered by fusion or to perform controlled nuclear transmutation.

In fact the entanglement, or non-locality of hydrogen isotopic species as H (Hydrogen), D (Deuterium), T(Tritium) that are momentarily overlap with the entanglement functions of the “burner” material (called electrode in the past electrolysis experiments) and the most frequently used was Pd (Palladium) makes these reaction possible. Initial lack of understanding of these processes made the reaction to have an unpredictable occurrence and non-reproducibility in many laboratories of the world. It has to be clearly stated that not only Palladium has this property but other materials as Pt, Ni, U, Pu, Th, etc. and only if the appropriate nano-structure and the appropriate excitation is applied.

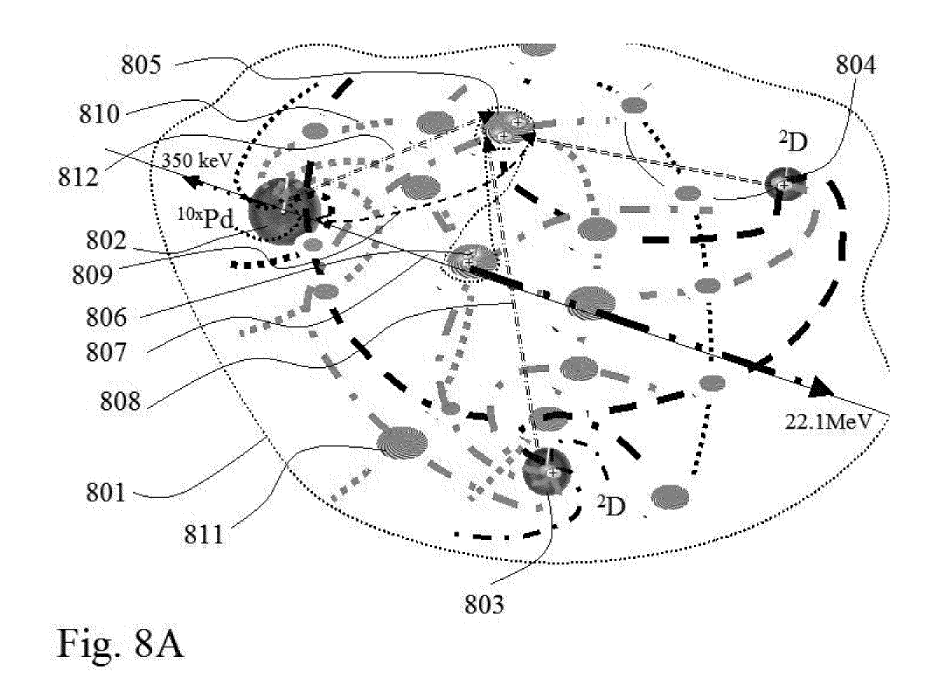

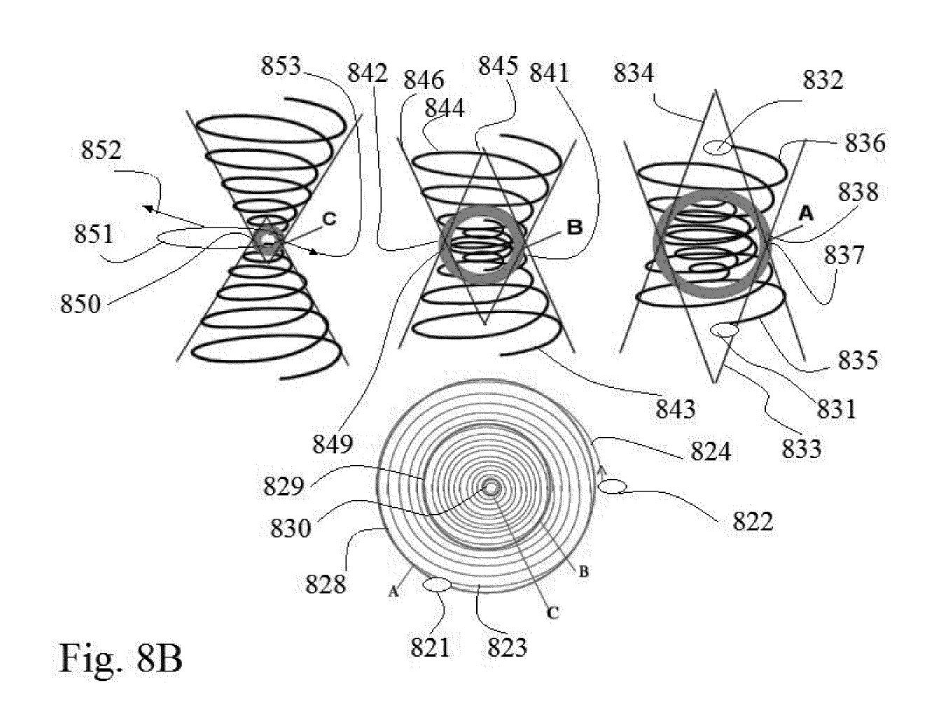

FIG. 8A shows a ternary nuclear reaction where two ²H (Deuterium) nuclei generically called “fuel” and a nucleus belonging to the “burner's” nanostructure makes via entanglement a unitary compound nucleus entangled in the lattices positions.

The 3 nuclei are interacting in a compound nucleus without “touching” each other in the classical sense of ion beam interactions that requires energy to penetrate through the Coulombian barrier in what we believed are the boundaries of the nucleus. There is also important to understand that a compound nucleus is not a sum over protons and neutrons present there but a wrap or loom of quarks, floating in the “meson sea”, in other words having more than 3 dimensions, and a neutron and a proton is the same entity, showing us 1 quark for each dimension of our 3D space, having a possibility to flip showing like a set of 3 magnets, a side uud=p or ddu=n, that has a lower stability, and a life time of 900s until flips back via a virtual boson w⁻.

The nuclear exchange is made at this level or at strong interaction units that operates in the case of fusion, transmutation, as well for fission, being no difference between them from this point of view of the nuclear reaction. This neutron decay is a process inverse to the e-capture, and in our universe the proton-electron coupling in H atom is more stable than a neutron. That is why the proton does not capture its electron to become a neutron in normal conditions.

This loom of quarks once entered in entanglement the exchange starts in order to recombine in a more advantageous manner from the point of view of nuclear stability and exhausting the surplus of energy as kinetic energy of the newly resulted particles. It is very probable that the initial ternary entanglement to produce new binary entanglement, following the conservation laws in new entanglement positions, based on center of mass, from where the surplus energy or defect of mass, is released, conserving the energy, impulse, spin, parity, etc., as kinetic energy of the particles and excitation energy of the particles, that is released at later times by various nuclear decay modes.

In this respect:

¹⁰⁵Pd+2²D→¹⁰⁵Pd+⁴He+22.4 MeV or may drive to

¹⁰⁵Pd+2²D→¹⁰⁷Ag+²D+0.02 MeV

In the reaction ¹⁰⁵Pd+2²D→¹⁰⁵Pd+2⁴He+22.4 MeV, Pd gets about 0.3 MeV kinetic energy producing a lot of dislocations in the lattice while He gets about 22.1 MeV traveling about 50 microns in the lattice.

This high energy, 22.1 MeV makes the particle travel a long distance of about 50 microns making possible the direct conversion of particle's energy into electricity. The structure used relies of the difference of the ionization energy deposited by radiation in different materials that drives to knock-on electrons induced electron showers that may be collected on electrodes of a super-capacitor structure and driven outside to the plots.

Up to this point, it was described the molecular excitation to nuclear reaction process, and remains to clarify how we can control the reaction rate in order to deliver power at will with high efficiency.

Under this aspect it is important to highlight that the fusion reaction delivers 22.4 MeV from which about 22 MeV, about 3 pJ (pico-Joules) are carried by the He nucleus, and may be converted into electricity, the rest of 0.4 MeV, about 2% are carried by Pd on short range and ends up in thermal energy. To deliver a power of 1 W, 3 10¹¹ reactions are needed, while for 1 MW a factor of 1 million more is needed.

In order to estimate the limits of this method and power source, we may consider a total conversion efficiency of 95%, and we know that up to about 1 kW/cm³ may be removed from the actual nuclear structures, it will drive to a maximum power density under 20 kW/cm³.

A further estimation may be considered the following—For each 10 microns of Pd structure, 100 microns of direct conversion structures have to be added. That makes 80 structures to be packed in 1 cm thick power source. If 1 fusion act takes place at each cubic-micron, about 1 at 343 billion atoms with a probability of 3 10⁻¹², about 10¹⁰ fusion acts are produced in 1 cm³ delivering about 30 mW/cm³ power. To have an acceptable technologic power supply one may need 30 W/ cm³, for which 1 fusion is required at every 100 nm apart, about 7,000 atoms lateral cube cell has to deliver 1 fusion per second, and that seems to be a reasonable value.

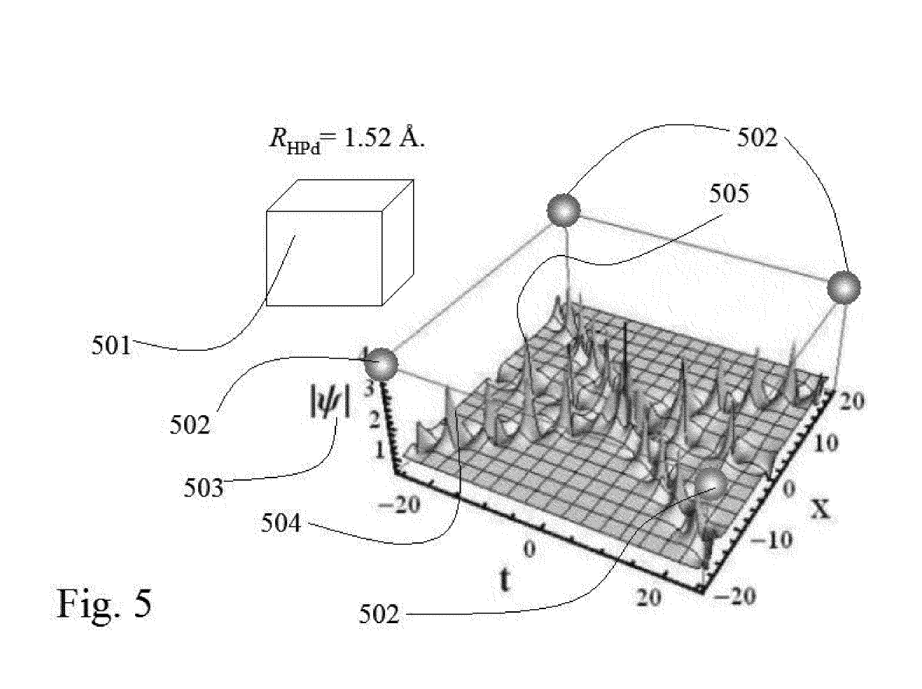

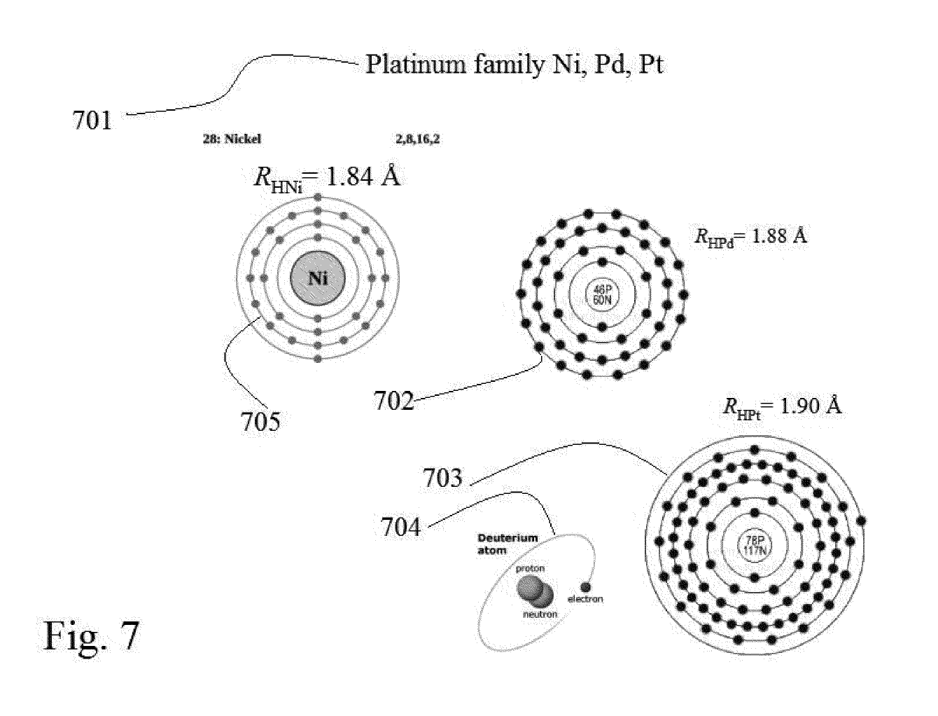

One important fact presented in FIG. 5 and FIG. 7 that are give the inter-atomic distance of the bounds, of about 0.2 nm. This makes 5-6 atoms per nm, and in 1 nm³ nanocluster 125-144 atoms of each type may be present. There is a tradeoff between the nanocluster dimensions that increases the probability of interaction with increasing the dimension and the compressibility of the nanocluster due to interface shape effect that shortness the distance between atoms making the probability of interaction grow with reducing the nano-cluster size. This contra-variant effect that finally gives the reaction rate may make the dimension range from 2.5 to 6 nm very interesting.

Another effect already known is the instability of pore Pd nanoclusters with the temperature. The grain nucleation effect makes the Pd nanocluster growing rate to grow with temperature increase. On the other side, we need high temperatures in the limits of dehydrogenation reaction, in order to create interstitial D that has a larger interaction probability than bounded D. The nano-cluster growth rate at this temperature will make the structure's operational lifetime shorter. In order to counterbalance this effect a dual or ternary structure including Ni and Ti, even Cr nanoclusters have to be put in place.

At special sizes, it may resonantly amplify the entanglement wave in interfaces, increasing the capability of structure self-recovery following nuclear reaction recoil dislocation cascade damage.

FIG. 8B describes the mechanism of a binary-nuclear reaction, a sub set of the FIG. 8A where a ternary reaction was described.

The two entanglement zones 823 and 824 (virtual spaces—structures of space without mass) at a moment of time t₀ are in the certain position where the mass overlaps with the space structure and the nuclear reaction engages.

The spirals 821 shows three potential fractal levels highlighted, representing the different moments of the “compound nucleus” interaction that in this case may take longer than in usual nuclear collisions—creating metastable structures similar to positronum—most likely known that have manifested in similar form into reality. The circles A, 828 respectively 838B 829, respectively 849 and C 830, respectively 850 are different moments in time of the entanglement vortex evolution, having the lateral projections above, simply called A,B,C as moments of reaction evolution time.

This vortex coupling is equivalent to a standing wave structures at each of the levels where the opposite interacts. (There are no stable forms or even time without counteraction and limitations.)

The perpendicular projections shows the three fractal shells formed by opposing spirals, creating standing waves in order to give an idea of the inner structure. In effect, we are describing a vortex matrix from which all forms may emanate.

This is the description of the mechanism of nuclear entangled transmutation, where a particle as Ni may interact with a proton at long range forming a quasi-stable compound nucleus that finally end up in a Cu and the kinetic energy transmitted as recoils in the lattice.

In the initial phase “A” the entangled arrays 831 generated by 832 occupied by a Ni, Pd, etc. atom are interacting. When another nuclear entity has space coordinates matching with the entangled array 831 the interaction starts, and follow a vortex model. The particle 831 follows the spiral 835 and the particle in 832 follows the spiral 836 inside the time cones 833 respectively 834 moving in opposite direction. The spirals are interpenetrating and counter-variant, shrinking during interaction time as the quark matching evolves towards a new stable structure, having the envelope of interaction space 837.

At the middle of the interaction at time B, 849 the entangled spot are near in the vortex 843 inside the time cone 845 from the counterpart entangled array 842 evolving counter variant on vortex 844 inside the time cone 846. This elapsed time is what takes for the quark structure to rearrange in a more stable configuration and is influenced by the entry parameters of the mass in entangled zones, generically called collision parameter, which influences the reaction channel followed.

In the last stage of evolution C, 830 and respectively 850 the quantum states takes a stand and the final masses are delivered together with the released amount of energy.

These might be stable stationary states—and there will be many in reality. Note that the spiral forms closed systems at these fractal levels (which on the negative side provide a mechanism of entrapment and evolutionary control).

In this moment the conservation laws take shape and the expansion of the reaction area 851 in the vicinity is “searching” for nearby partners to share the process and contribute to final delivery, driving to a sequential triple entanglement that repeats on a perpendicular direction the phases A to C. If the process is successful the new products or energy states are delivered.

The entered matter is reshaped in more stable compounds and the excess of energy is released as kinetic energy of the novel compounds. Inside a lattice this is transformed in recoils of the lattice elements. The two particle released 852 and 853 are traveling the space in opposition conserving all the parameters.

This is a ternary fusion reaction facilitated by the proximity inside nano-structures doped with addition elements because a three initial mass bodies (the energy is stored as mass) combine in the ternary process driving to only two resulted mass elements recoiled from the initial position. It remains a good probability that the three elements to interact but do not reconfigure, the energy balance driving to some other excited states, that may go as far as the nano-cluster boundaries, or generation of other particles.

The transmutation reaction where the dopant say Hidrogen, Deuteriu, Tritiu, etc. is capture by an element of a solid structure usually a nano-crystal say Platinum, Plalladium, Nickel, etc. nuclei obviously requires the overcoming of an electrostatic potential barrier which opposes the process.

As an example for ⁵⁸Ni (the more abundant of the Nickel isotopes), reacting with Hydrogen driving to Copper, the maximum electrostatic potential energy Vₘₐₓ occurs at a distance d between Ni and proton nuclei centers equal to the sum of their nuclear radii, that is d=7; 239 fm. The Vₘₐₓ=5.6 MeV=0.89 pJ.

At room temperatures the Hydrogen energy is of about 25.3 meV, far too small to overpass this barrier.

Such an opportunity, in principle, is given by the quantum mechanical tunnel efect: in this case, the incoming particle can penetrate into the nucleus by getting through the potential barrier. The tunneling probability of a single particle colliding with an atomic target is about 10⁻¹⁰⁰⁰, so small as it may even not being considered. Electronic vortexes were experimentally observed in stellar gas, known as Debye-Huckel shielding effect, that may be applied in solid matter case too and comes to reduce the effective value of the barrier from 5.6 MeV down to about 3 MeV in metallic Ni. To this adds the electron screening effect of both nuclei that produced an increase of the nuclear cross section reaction published by F. Raiola in Eur. Phys. Journal A 13, 377 (2002), A 19, 283 (2004), A 27, 79 (2006).

To this the original addition is the nuclear entanglement zone propagation controlled by the nano-cluster eigen-modes that brings several orders of magnitude for the process at resonance. Quantum entanglement and string theory are hot subjects at the moment and here is not the place for entering in such a debate.

What is important for this application is the fact that controlling the isotopic composition of the nano-clustered matter and the doping is possible to control the reaction cross section in real time, making the process possible and reproducible.

In spite from the point of view of already classical nuclear reactions physics there are distinctly treated the fusion, fission and the transmutation, in fact there are manifestations of the same phenomena—the search for stability by rearranging the energy stored in mass effect that may take place in binary reactions—collisions that requires over the threshold initial kinetic energy or ternary reactions that requires nuclear and atomic parameter matching in something called resonance.

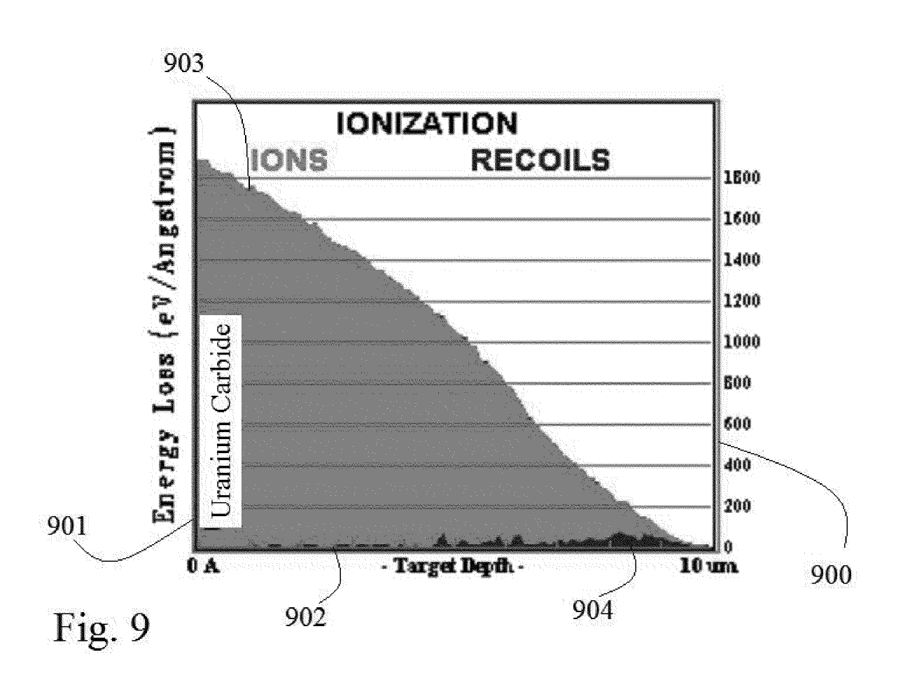

FIG. 9 shows the energy deposition of the 5 MeV alpha particles in Uranium carbide a potential very dens material possible of being used in the fusion source fabrication as harvesting electrode. The alpha particles are coming in the material at normal incidence are stopping in less than 10 microns.

The FIG. 9 shows the Energy Loss in [eV/Angstrom] 901 for the particles due to the interaction with the electrons 903 process called ionization and due to the interaction with atomic nuclei, called recoils 904, with the values plotted on the right ordinate 900 as function of depth from the surface 902.

The figure shows that ionization 903 is the dominant energy deposition process, and this generates knock-on electrons that generates other knock-on electrons creating avalanches.

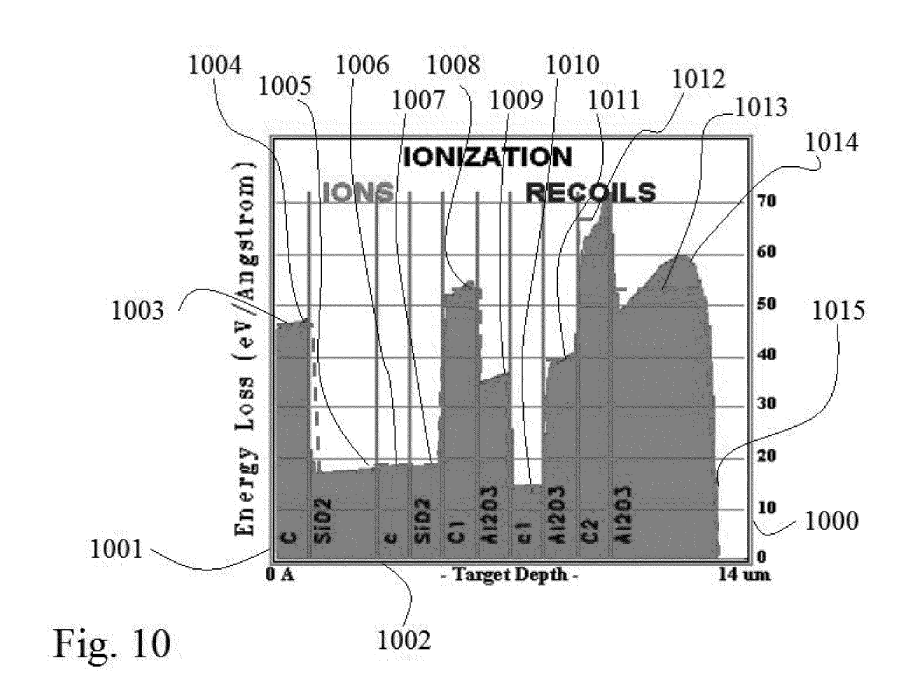

FIG. 10 shows the same process, the stopping of 5 MeV alpha particles in matter, but this time taking place in a sandwich of different materials simulating a super-capacitor elemental cell structure generically called “CIci”. The structure uses a high electron availability conductor material “C”, 1004, that is a material that exhibits high electron number, high Z (atomic number), high mass density and low extraction work all together giving a high forward multipactor number. As a supplementary condition is desired to have a low backward multipactor, therefore the passing through nuclear particle to extract a big forward electron shower.

The first layer “C” that can be made of gold, Uranium, etc., is insulated by a layer “I” 1005 that usually can be made of silica, alumna, nitrites or carbides and has to have moderate to low electron emission.

The electrons produced in the layer “C”, are tunneling through the layer “I”, and are collected in the layer “c” 1006, that is a conductor material with low electron density as graphite, aluminum, magnesium, Lithium or Lithium-Hydride (LiH). This layer collects the previously generated shower and emits a very little shower, or none. In this way it gets negatively polarized. The structure is further insulated by a layer “i”, 1007 that can be an oxide like alumina, silica or a carbide or nitride.

After this first elementary cell another one follows having about the same structure but different dimensions and materials. In the figure the layer C1, 1008 and C2 1012 are made of the same materials. They are followed by the insulators 1009 respectively 1013 made of alumina, and the low electron availability layer “c1” 1010, insulated from the next cell by an alumina layer 1011. In the plot 1001 is shown the ionization power deposition 1003, as “Energy loss in eV/Angstrom on the ordinate 1000 as a function of penetration depth 1002.

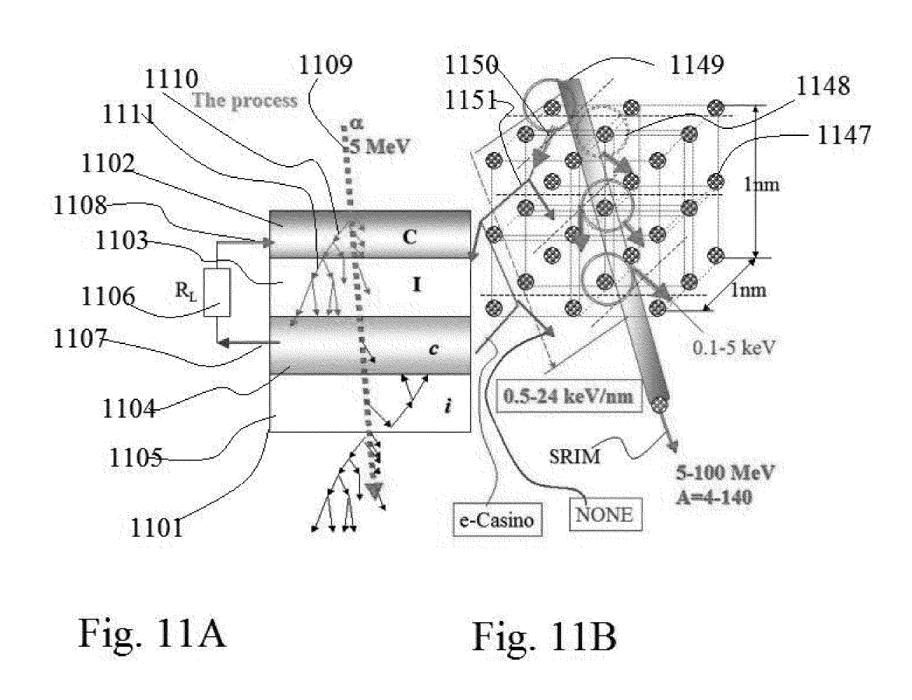

FIG. 11A shows the elementary “CIci” structure 1101 crossed by a 5 MeV alpha particle 1109, that is stopped in the layer “C” 1102 emitting a shower of knock-on electrons 1110, that further interacts with other electrons 1112 generating an avalanche.

The alpha particle, having an average energy of 5 MeV is directing towards the elemental “CIci” conversion structure 1101. The alpha emitters energies are varying from 4.6 MeV up to 5.6 MeV, having an average value about 5 MeV, while the fusion-emitted alpha has up to 11.4 MeV. The conversion structure that is made on a plurality of “CIci” elemental units to cover the stopping range of the particles in that structure.

When the particle 1109 encounters the layer “C” 1102 abundant in available electrons, it generates many knock-on electrons 1110, that at its turn collides with another electron 1111 knocking it out two, and sharing the energy and impulse, and so on until all electrons that now form a shower tunnels through the insulating layer “I” 1103, reaching the layer “c”, 1104, that is a low electron density electricity conductor material.

The “c” layer 1104 is a conductor material that did not has enough stopping power and produces a small electron shower behind, that may tunell the insulator “i” 1105 and reach the next “C” layer after it.

This mechanism is polarizing the conductive layers 1102 positively and 1104 negatively. An exterior electric circuit is needed to connect the negative plot 1107 on the “c” layer 1104 via a resistor R_{L} 1106 to the positive plot 1108 on the “C” layer 1102 and allow the electric charges return at the place from where were dislocated by the alpha particles. The current's energy is further transmitted outside the structure.

FIG. 11B represents a zoom-in in the “C” layer 1102 on the alpha particle track 1109 being labeled here as 1149, that includes the trajectory inside the atomic structure. The zooming element contains a cube of about 1 nm lateral with about 27 atoms. Supposing that the material is Uranium with Z=92 the cube volume contains 27×92 available electrons from which about 100 are affected by the direct crossing of their orbital by the alpha particles and share the ionization energy.

The alpha particle 1149 is crossing an electronic orbital and makes an electron there 1150 knock-on. This electron collides with another electron and changes its path on 1151 while transfers to the colliding electron a part of its energy and impulse. To simulate the behavior of the first electron a Monte Carlo (MC) code may be used as e-casino, but it does not track the secondary electrons. To track alpha particles a code named SRIM was used, and also MCNPX, both being MC codes.

After the first collision of the alpha particle 1149 with the electron 1150, other atomic orbitals 1148 are crossed with the same consequences. The shock wave of the moving electric field of the particle passing through propagates far in the structure but due to short interaction time well under 1 ps (pico-second) the atoms 1147 are not removed from their position.

The energy of alpha particle is in the range 0 to 12 MeV, while other elements as fission products may well have energies up to 100 MeV; cosmic particles are going in GeV domain but the structure will not be customized to stop them. The purpose of the present structure is to harvest and transform in electricity the energy of the fusion generated particles as transmutation recoils and by product light particles as in the atomic number range from 1 to 6, mainly Hydrogen and alphas, as well as energetic neutrons.

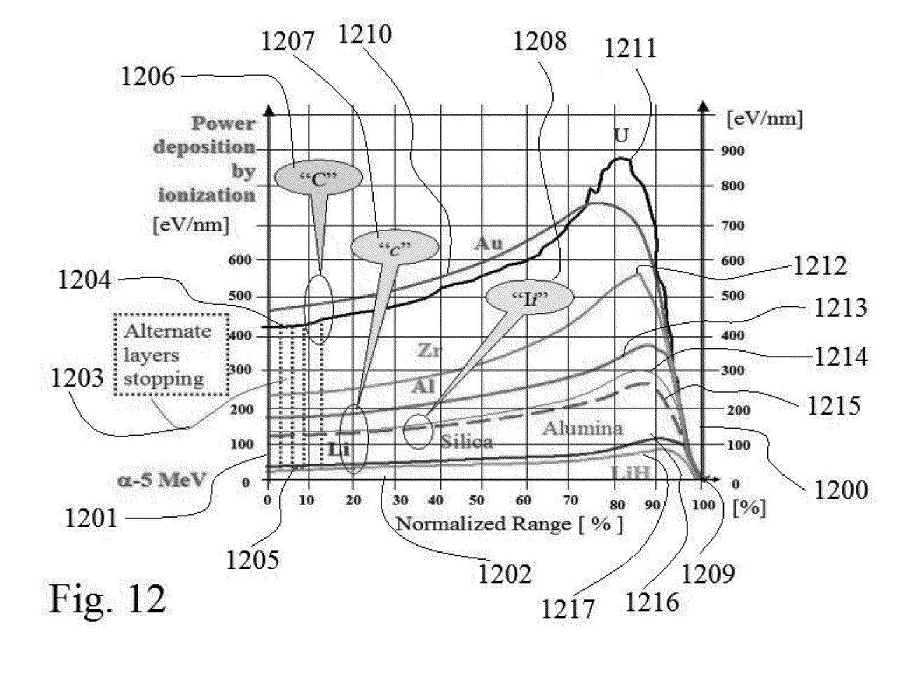

FIG. 12 represents a synthesis of the stopping power of 10 MeV alpha particles in various materials, in order to briefly understand how these materials may be used to make the harvesting elements inside the “CIci” elementary harvesting cell.

On the ordinate 1201 is plotted the Power deposited by the alpha particle in materials by Ionization in [eV/nm] (electron-Volt/nanometer), and the right ordinate 1200 shows a complete scale. The abscises 1202 represents the normalized path in percents of the maximum range of each particle.

At the left side of the chart the dashed line 1203 shows a possible “CIci” structure by alternating various materials at choice, that are grouped in classes as “C”, high electron availability conductors 1206, “Ii” insulators 1208 or low electron availability conductors “c” 1207. The sandwich structure depending where on the particle energy range is placed is harvesting an energy in ‘C″ equal with the thickness of the layer 1204 in [nm] multiplied by the average energy on the ordinate in [eV/nm], from which we have to subtract the energy deposited in the “c” layer 1205 obtained by multiplying its thickness in [nm] with its average power density in the relative position on the stopping range.

The result will be transformed inside the nano-layer in electric energy that is the product between the accumulated electric charge and the polarization voltage between the “C” and “c” layers acting as capacitor foils.

In the chart are plotted as example various known materials with high potential of being used to build the structure as Gold 1210, Uranium 1211 in the “C” class, aluminum 1213, Lithium 1216, LiH 1217, in the “c” class, alumina 1215, silica 1214 in the “Ii” class and tin 1212 as a material that may be used with care not being in any class, but in some conditions a tin-Lithium structure may operate as well. The “C” and “c” classes are relative to the available materials and technologies, the only condition is that the electron availability in “C” class to be greater than in “c” class, both being electricity conductive materials. Even if one by mistake ignores this rule it my have an inverse polarization, as long as these materials are different.

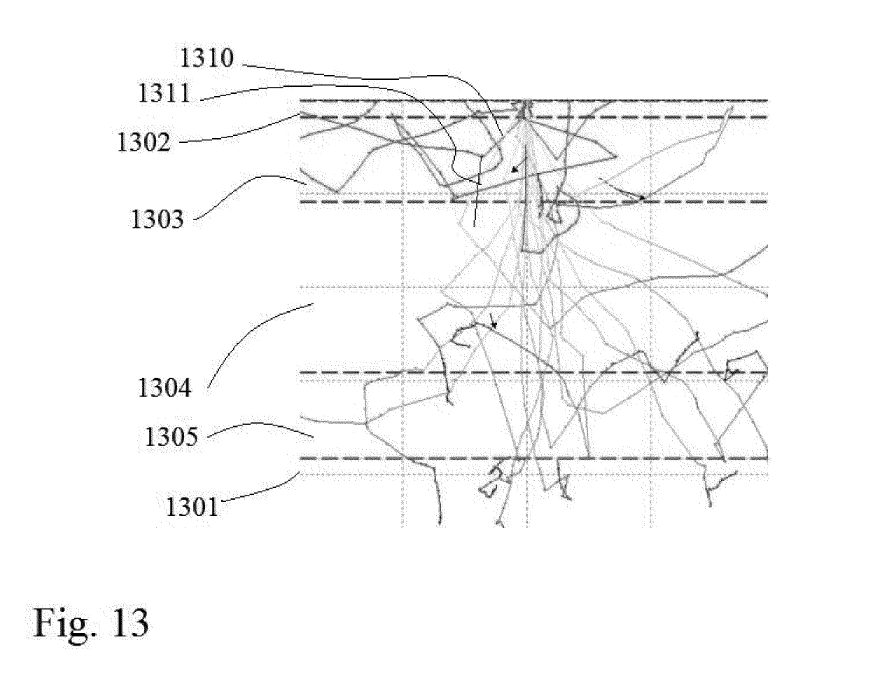

FIG. 13 shows in intentional very low statistics the behavior of the knock-on electrons being generated by the previously presented ionization process. The drawing 1301 represents a section along the particle axis, showing the behavior of knock-on electrons 1310.

The knock-on electrons generator layer “C” 1311 is made of 8 nm of Gold, it is followed by a 20 nm thick silica layer 1303 separated from the previous layer by an interface 1302 that may exhibit a special deposition in a very narrow layer called “delta layer” with the goal to optimize the electrons emission and direction, by developing atomic and molecular electric and magnetic fields. The layer 1302 has also the role of bringing chemical and mechanical stability and increase the robustness to radiation damage. The delta layer will develop a nano-clustered structure having specific thickness under 3 nm. The nanoclster magnetic moments in this position will drive the electrons to tunnel through 1303 insulator with no significant loss towards the collector layer 1304 build of aluminum in this example.

A delta layer may be also applied on the interface 1303-1304 with the role to turn the electrons along the layer and to maximize the stopping of the electrons in this layer. A Ti-Fe-Co layers with the magnetic moment along the interface may be used. Some other magnetic nano-clustered layers may be used in order to make the electrons 1311 balistically drift through insulator “I” 1303 and turn, and stop in the “c” layer 1304, 40 nm thick for this simulation purpose only.

The layer “c” 1304 is followed by the insulating layer “i” 1305, that is made of Alumina and is 20 nm thick in the simulation. This layer is separated by another 6-layer, represented by a dashed line separating the “c” layer 1304 from the “i” layer 1305. This interface layer, generically called delta exhibit high magnetic moment designed to turn back the electrons emitted by the “c” layer. The “i” layer is followed by a cell termination 1301 or may be followed by another “CIci” cell.

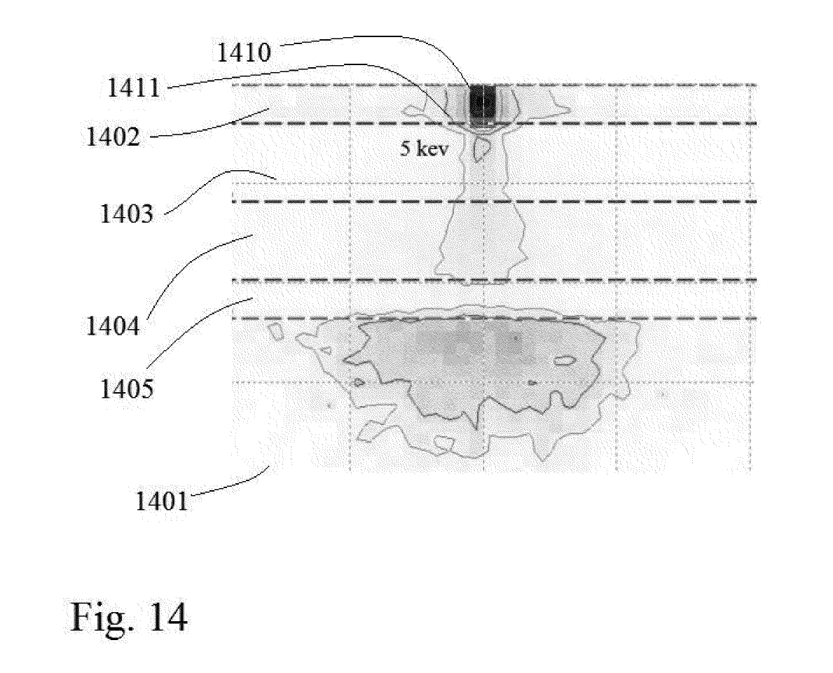

FIG. 14 shows the electrons density distribution inside the nano-layers. It is seen the central spot 1400 where a high amount of electrons are created. These electrons are further colliding inside the “C” layer 1402, reducing their density distribution 1411 and leaving the layer. They are tunneling the insulator “I” 1403 and stop in the “c” layer 1404 which at its turn has some electron generation that further tunnels through the insulator “i” 1405 and stops in the substrate 1401. Because the electron energy has been set on maximum currently achievable from alpha particles a part or electrons generated in 1401 are tunneling in 1401—where in normal conditions encounter another “CIci” cell, multiplying there in the “C” layer, and the process repeats. This process assures a high polarization of the conductive layers, that further assures a good conversion efficiency.

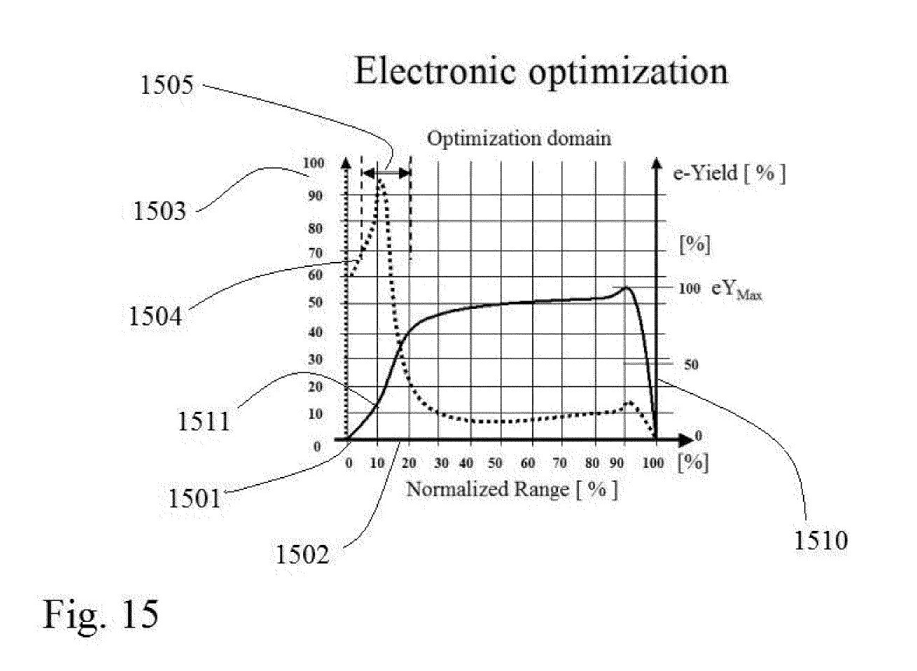

FIG. 15 shows the experimental optimization procedure. Previously have been showed that depending on chosen materials, interfaces and position in the stack the electron generation is different and has to be optimized, to be a maximum and in harmony with the other cells in the pack.

This is a complex process that has to be made at the buildup of any new structure.

The chart in FIG. 15 shows the electronic optimization that have to be done in an ion beam assisted vacuum deposition unit. The chart 1501 is in relative units. The operation shows a continuous deposition of a material while measuring the forward scattering or multifactor of the electrons 1511.

One may observe that when the layer is very narrow, there is not enough production rate and the energy deposition is low. After the thickness grows over 20% of maximum on the abscises 1502 the grows rate is decreasing drastically and the curve 1511 flaterns, and so it does up to the end where it may get a bump due to the change of the ionization rate towards the end of range. And soon after that it starts to drop until comes back to the background emission.

The values are shown n the right scale 1510 showing the maximum yield and the maximum length for transmitted electrons. The normalized range is a little bit bigger than the stopping range of the alpha particle in that material.

Another important curve is the growth rate of the electron emission with the thickness, 1504, simply the tangent at the first curve, 1511. This curve exhibits two local maximums, one at the beginning in the area 1505 that presents a special interest and one at the end. The values of this curve 1504 are plotted on the left ordinate 1503 also as a function of position 1502.

In the optimization area, 1505 what is measured is the worth of extra material added, because after the curve 1504 is reaching the first maximum, adding more material brings less extra electrons to the electron shower, but the electron energy is coming smaller and with the right tunneling through the Insulator “I” it may drive the device to maximum harvesting efficiency.

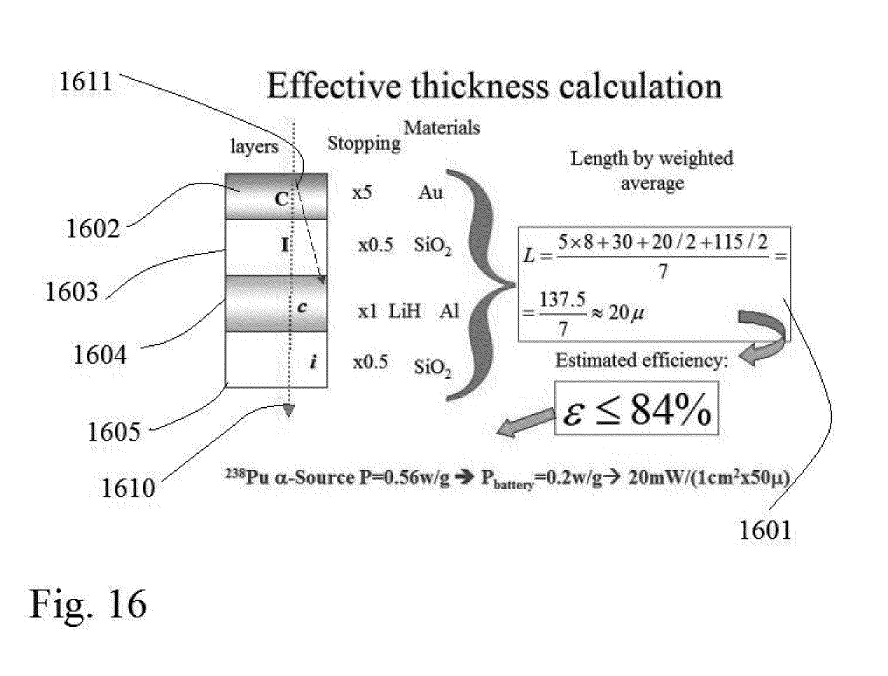

FIG. 16 shows some calculations for the effective thickness and a model of elementary fusion products energy harvesting cell.

This is just an example of an indirect calculation method applied

The “CIci” structure was calculated at an energy of 5 MeV, the most probable used because also matches the alpha decay not only median alpha energy in fusion applications.

The alpha particle 1610 penetrating the layer “C” 1602, knocks-on the electron 1611, that creates a shower, by secondary collisions with other electrons, drifts through the layer “I” 1603 and stops in the “c” layer 1604, that is insulated at its turn by the layer “i”, 1605. Surpassingly that all the energy deposition of the alpha particle 1610 crossing these layers is of about 7 units and only 5 units represents energy absorbed in layer “C” the maximum efficiency may be as high as 84%. Of course, some other effects that need to be mitigated will make it smaller, but what was intended to be shown here was this upper limitation.

The calculation 1601 shows this and also says that these ratios have to be applied all along the 20 microns stopping range of the alpha particle in this combination of materials repeating homogenously all along the path. The structure is a nano-hetero structure in the class of meta-materials.

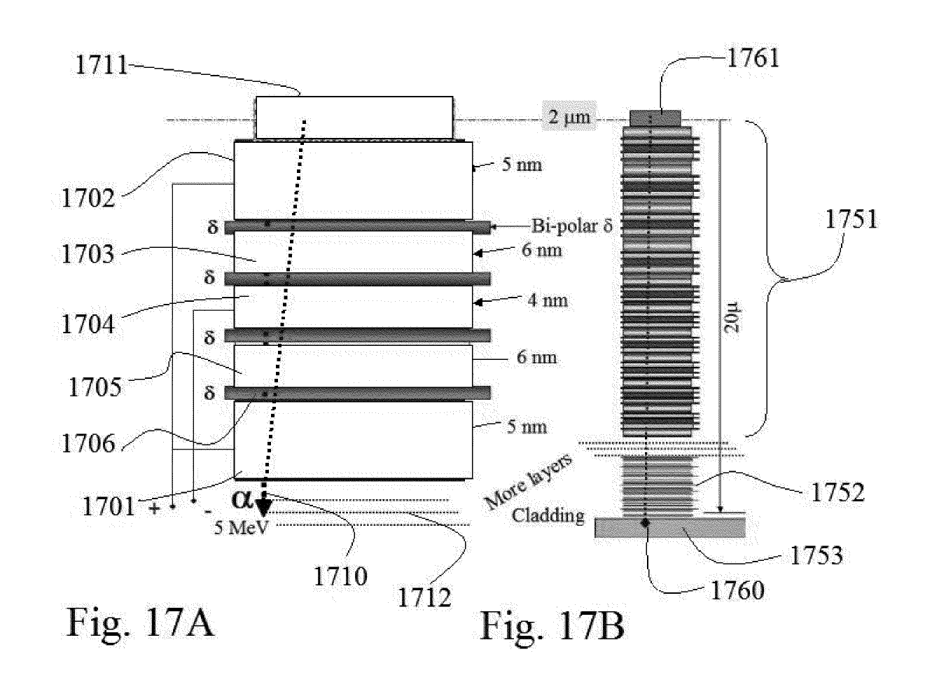

FIG. 17A is an exemplification of an elementary “CIci” cell as previously discussed at FIG. 13, where the delta-layers making the interfaces between main elements of the harvesting cells are visible, and some dimensions are provided.

The alpha source 1711 is placed in direct contact with the conversion structure. It can be a fusion system, or a isotopic source or a fission particle generator, or an accelerator beam. The alpha particle 1710 appears in the source 1711 and crosses all the layers of the energy converter slowing down to rest.

The “C” layer 1702 is electrically connected to the rest of the cells by cables starting from the plots of the armature. In this type of material the particle 1710 is dropping most of its energy.

The particles generated in “C” layer 1702 are adjusted in the delta layer separating from the insulator “I” 1703, and redirected by the next delta-layer between the insulator “I” and the “c” layer 1704. Further the electrons generated in the “c” layer are returned in “c” layer by the combined action of the delata layer and the insulator “i” 1705.

The backscattered multipactor electrons emitted by the next “C” layer 1701 are driven by the delta-layer 1706 straight into the conductive layer “c”.

A plurality of elemental conversion cells 1712 have to be used in order to achieve the optimal energy conversion into electricity, that has to span over the entire stopping range of the particle of interest.

FIG. 17B shows the structure of a conversion pack, using the source 1761 of nuclear particles 1760, that are passing through an elemental module made of a plurality of conversion elementary “CIci” cells 1751. There are several such modules, customized on energy 1752, that are stabilized in the support 1753, that has the role of stopping light radiations and give the necessary mechanical rigidity.

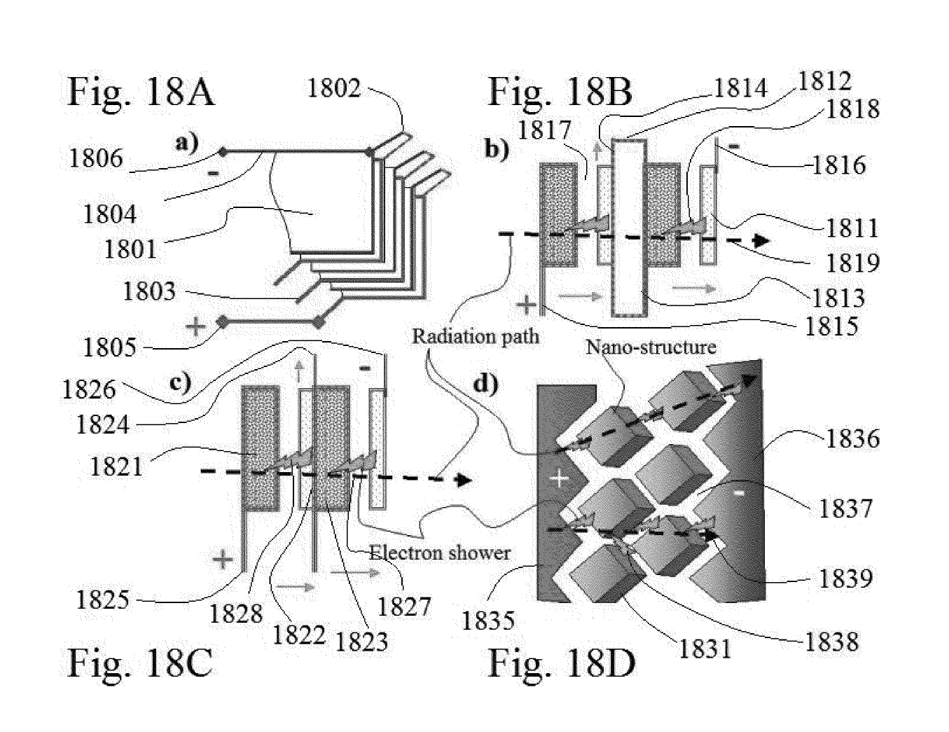

FIG. 18A Shows a stack of 3 “CIci” harvesting structures 1801 where the positive armatures 1803 and negative armature 1802 are forming poles, that are connected in series, at the pole 1802. The negative armature collecting wire 1804 is further connected to the negative pole of the pack 1806, and so the last positive armature is connected to the positive pole 1805.

FIG. 18B shows what happens inside the capacitor when we operated the connection in series as shown in FIG. 18A in a longitudinal section through the “CIci” 2 consecutive elemental cells. The radiation path 1819 crosses the cell's foils producing knock-on electron showers 1818 that start from the “C” layer, the positive armature crosses the dielectric “I” 1817 and stops in the negative armature “c”. The extreme positive and negative armatures are connected to the positive pole of the pack 1815 and respectively to the negative pole of the pack 1816. To achieve the serial connection the inner “c” armature's pole 1814 is connected by the strap 1812 to the next cell positive armature's pole 1813 bypassing the insulator “i”, that has no functional role.

FIG. 18C shows the same section in the 2 elementary “CIci” pack from FIG. 18B where the insulator “i” have been removed.

The alpha particle 1827 penetrating through the structure generates knock-on electron showers 1828 in the layer “C” 1821 connected to the pack's positive pole 1825. The shower tunnels through the insulator “I”, and stops in the armature “c” 1822, electrically connected through the interface delta layer 1824, where the electric strap have been reduced and eliminated, to the next “C” layer 1823. This layer at its turn is generating another electron shower that reaches the last in the pack “c” armature connected to the negative plot 1826.

FIG. 18D shows a evolutionary step. It is known that the nano-layers are sensitive to thermal expansion differences and cracks easily, therefore the smaller the structure the smaller the thermal differential stress is.

Because the structures in FIG. 18C was resembling a stack with floating-voltage elements inserted in insulator, the foils may be cut in smaller slices, resembling flat-nano-beads made of bimetallic material.

This transformation maintains the positive pole 1835, thin enough for the particles 1839 to penetrate it, but thick enough to have a good mechanical stability. The insulator “I” separates the pole, from the bimetallic bead 1831 that takes the knock-on electron shower 1838, and it is allows passing forward to the next bead allowing the electric field to build-up. The nano-beads 1831 are separated ny the insulator “i” 1837 from the negative pole 1836 that terminates the cell. The structure is equivalent with a 3 pack elementary cell shown in FIG. 18A because it has about 3 insulator arrays that builds the voltage while the metallic nano-beads inserted in the insulator assures the electron current flow.

This nano-material is a special meta-material as relies on bead insulator interfaces and beads polarization, developing also secondary effects as plasmon-polaron resonance and excited electrons stripping making simultaneously the thermal electrons training and conversion in electricity. The thermal energy conversion by switched commutation in electric circuit matters less to the energy balance, but some cooling effects may be observed as associated with this direct energy conversion in this type of meta-materials.

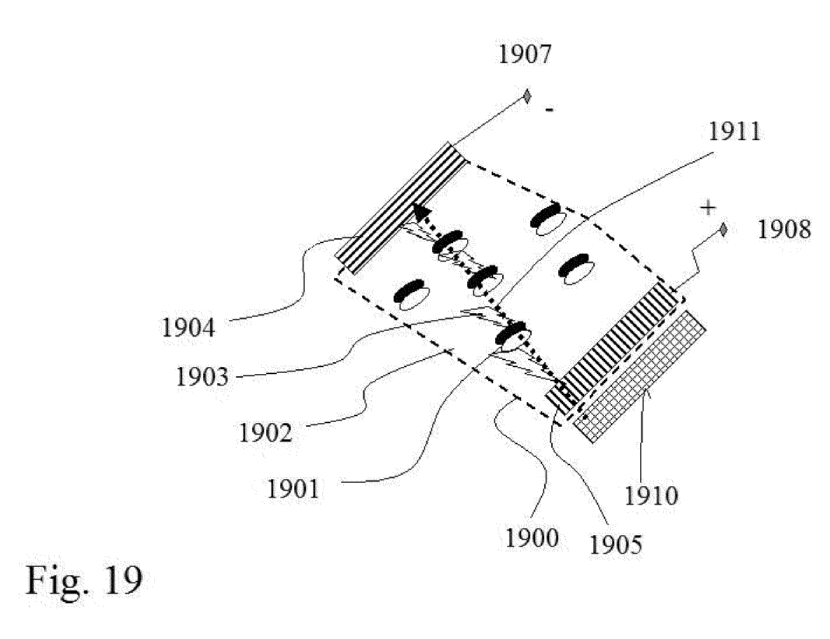

FIG. 19 shows a battery structure made of nano-beaded meta material as a section in a larger structure limited by the border dashed lines 1900. The radiation source 1910 is placed over the positive plot “C” 1905 but may also be incorporated in. A particle 1911 crossing the structure hits the beads 1901 and generates knock-on electron showers 1903. The dielectric 1902 is holding the nano-beads 1901 in suspension and at such a distance to allow that the electron showers to make a continuous flow from the generator armature “C” 1905 connected to the positive pole 1908 to the absorber pole “c” 1904, connected to the negative pole 1907, and from there return via an electric circuit.

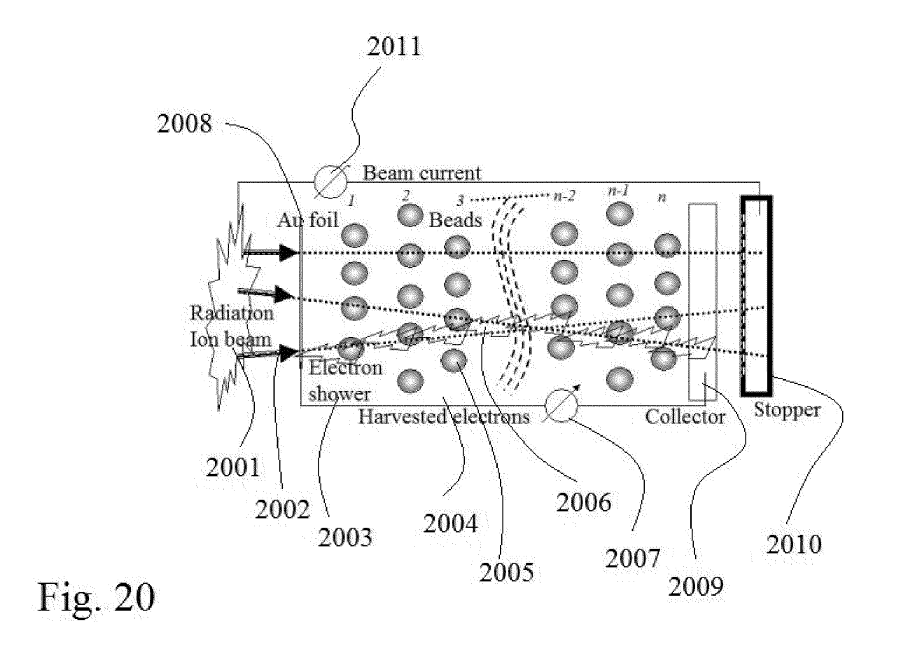

FIG. 20 is a view of an experimental setup made in order to measure the performances of a meta-material nano-beaded structure by using an ion beam supplied by an accelerator of from a collimated and energy filtrated alpha source.

The radiation or ion beam 2001 is generating particles 2002 that are passing through a thin gold foil 2008 used to measure the beam current from the backscattered multipactor electrons and may as well serve as the input electrode “C” that creates the electron shower 2003 inside the structure. The nano-beads 2005 maintain the electron shower and drives it along the particle's path 2006 across the insulator “I” 2004, towards the other end 2009 at a “c” conductor, that is connected to the first electrode through a IV (Current Intensity—Voltage) measurement device.

Because the structure is few microns thin, the beam passes through and a radiation stopper 2010 usually a faraday coup is used to measure the beam intensity in the instrument 2011. The beam current that stopped in the structure may be optionally measured by a similar instrument with 2011 or it may be grounded.

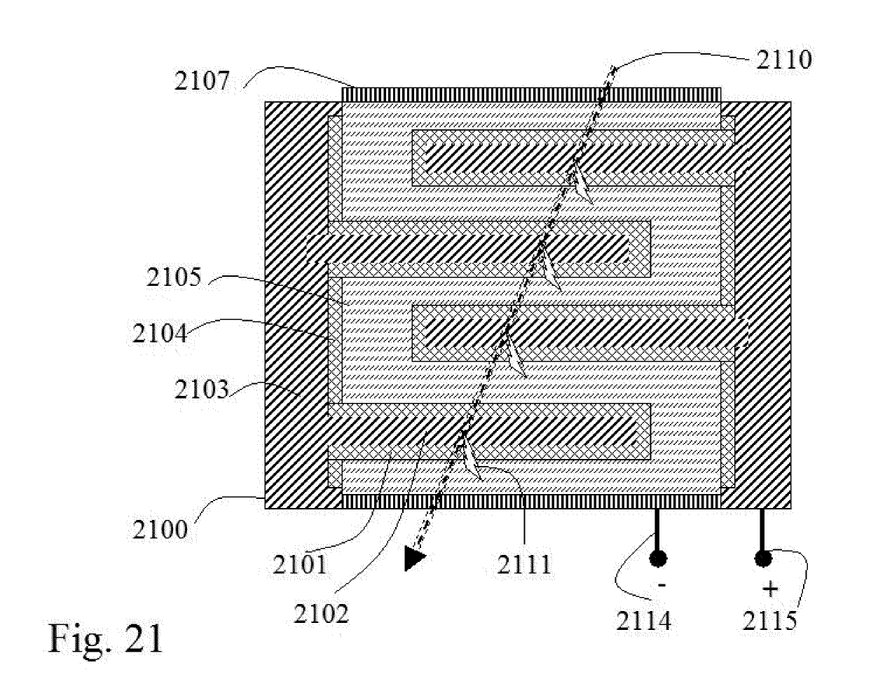

FIG. 21 shows another energy harvesting cell 2100 evolved from the “CIci” concept. That relies on loaded nano-tube (LNT) or coated nano wire (CNW) 2101 that assures good longitudinal conductivity and insulator grade transversal conductivity connected to a “C” class lateral walls 2103. The core of the LNT or CNW 2102 is made of “C” conductor or salt material, covered inside the structure. The structure is soacked in a conductive low density material 2105 that can be LiH, MgCl, Na etc sealed by the lateral walls 2107 made of a “c” material. The “C” material is coated in a protective layer 2104 that also seals the nano-structures.

The radiation particle 2110 crossing the nano-structured energy harvesting cell 2100 is crossing the “C” material embedded in naostructures 2102 and generates knock-on electron showers 2111 that are stopped in the “c” filler 2105 and driven to the negative poles 2114 and via an external circuit to the positive pole 2115.

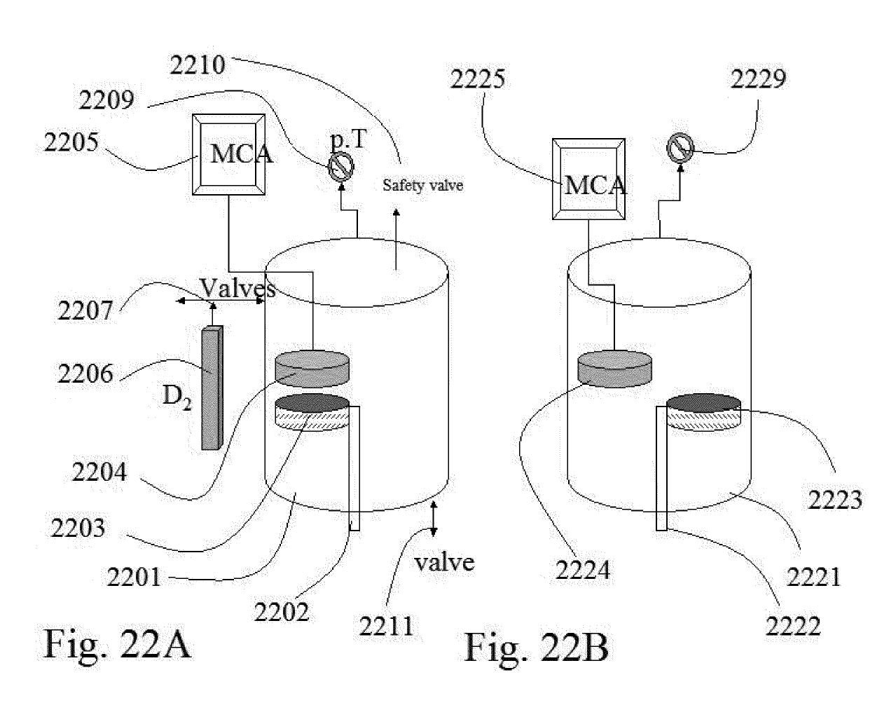

FIG. 22A shows the experimental setup to measure the nuclear reaction yield of the nano-structures. It is made of a sealed chamber 2201 that contains a moving support or sample holder 2202 that may have adjustable positions. The sample to be measured 2203 is set on the holder table, that have capabilities of thermostat and electric field control being insulated from the ground.

The chamber is equipped with electric signal passes through, and fittings for ambient atmosphere control. A n input valve 2211 is used to introduce the desired isotopic gas inside, or flush the chamber. Another set of valves 2207 are used to control the “combustible” gas input. In this case we used Deuterium stored in a bottle 2206. A safety valve 2210 that is meant to mitigate the avalanche burning danger that can drive to step pressure increase and at least a set of atmosphere measurement devices as pressure, temperature, composition are recommended 2209.

The system also is equipped with a charged particle detector 2204 and a specific multi-channel analyzer (MCA) that detects the nuclear particles produced in the sample as a function of sample control parameters.

FIG. 22B shows the same setup with the experimental chamber 2221 containing the sample holder 2222 in a remote position with the sample 2223 on. The charged particle detector 2224 connected to the MCA 2225 is measuring the background radiation effect, as function of the inner gas parameters controlled and measured by the system 2229.

The experiment is making a background calibration and detection system test using the position in FIG. 22B and after that the sample is brought in the measurement position shown in FIG. 22A, and the test program is run. The result will give the dependence of the reaction rate on the control parameters.

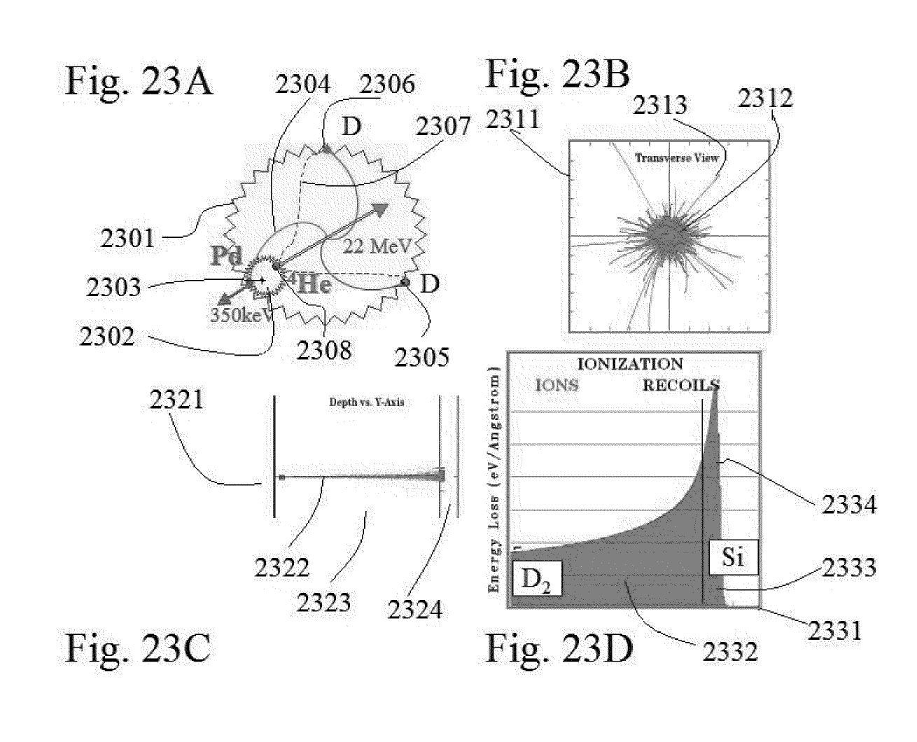

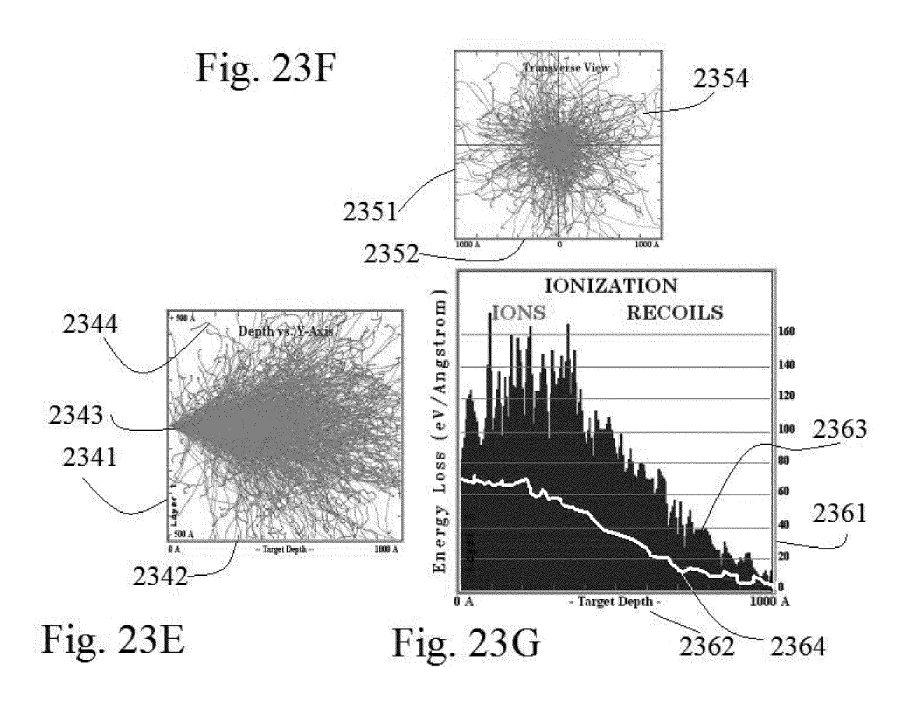

FIG. 23A shows the triplet entanglement reaction where two deuterium atoms and a Palladium atom are interacting opening various nuclear channels.

The most interesting of all is the aneutronic fusion that combines the two deuterons into an alpha particle shooting the alpha with about 22.1 MeV and generates a 300 keV recoiled Palladium atom.

Other possible nuclear reaction channels are the Palladium transmutation in various combinations up to a Z+2; A+4 transmutation, shooting back the residual products as neutron, hydrogen, Deuterium, tritium, even beta or gamma.

The FIG. 23 considers the deuterium fusion only, vhere the two deuterons 2305 and 2306 get entangled with the Palladium 2303 in a vortex reaction zone 2301. The entanglement lines 2307 makes the mass swap from their initial positions to a new structure most preferred entanglement spot 2308 moving Palladium mass in the position 2302 from where the split reaction starts shooting the alpha particle and recoiled palladium in opposite directions, with the energies resulted from the conservation process.

Another possible process is the creation of a meta-stable structure stable in the vortex 2301 that locks together the three particles, similar to the positronium (an electron and an anti-electron spinning around each other) molecule, delaying the nuclear process for variable times depending on the nano-structure parameters...

Note: many other materials may be used instead Palladium and Deuterium, that drives to same results. For example nano-structures of Ni, Pt, Th, B etc. may also be used in combination with the counter part atoms as H, D, T, ³He, Li, etc. combining the isotopes in such a manner that a possible better nuclear combination to come out by transmutation or fusion. Heavy nuclei are prone to fission in the presence of the appropriate structure that to drive them to a more stable combination, but due to large electronic structures the probability of reactant nuclei stepping in the entanglement spots is drastically smaller than for the Pd—D case, but possible.

FIG. 23B shows a plot of a view along alpha particle axis showing their lateral distribution in the chamber where leaves the sample, passes a 10 mm Deuterium atmosphere at 1 bar and 300 K, and hits the barrier detector made of silicon. The ordinate shows the x axis 2311 while the abscises shows the y axis in the transversal view where in center there are the bunch of alpha particle trajectories 2312, and very few particles suffer accidental collisions 2313 scattering away from the bunch 2312.

FIG. 23C is a lateral view of the path or the alpha particle from the Palladium source 2321 through the deuterium atmosphere 2323 and stopping in the Si detector 2324. The particle beam 2322 is almost entirely crossing the separation gap full of Deuterium reaching the detector.

FIG. 23D shows the ionization range of the 22 MeV alpha particles in the detection structure made of 10 mm of Deuterium gas 2232 and the Si barrier detector 2234. The chart shows the variation of the power deposition by ionization 2233 as function of the distance from the palladium source 2231 on the abscises. It is clear that for a 1 cm distance from the sample almost all the particles make the way to the detector.

FIG. 23E shows the path of the recoiled 300 keV Palladium. For a distance of about 100 nm=1000 Angstroms. The transversal view shows the behavior of recoiled Pd 2343 inside a Pd lattice. This shows that there is possible to include the Pd Inside a “CIci” conversion cell off about 200 nm large, using the Pd as a “C” armature and having Pd ions migrate among the armatures. Due to the fact that this is a highly recoil damage energetic zone, the Pd burners will have to be frequently replaced.

The figure shows the lateral view of the potential trajectories 2344 of a recoiled Pd 2343 as function of target depth 2342 and target height 2341.

FIG. 23F shows the frontal view of the potential trajectories 2354 of the recoiled Palladium inside a Palladium metal as function or with 2352 and height 2351.

FIG. 23G shows the 300 keV recoiled Palladium energy deposition by ionization 2364 and by recoils 2363, with the values plotted on the ordinate axis 2361 as function of depth 2362. It shows a maximum of 1.6 keV/nm is possible to deposit, that makes the application of a layered harvesting structure very interesting because it may deliver high power density.

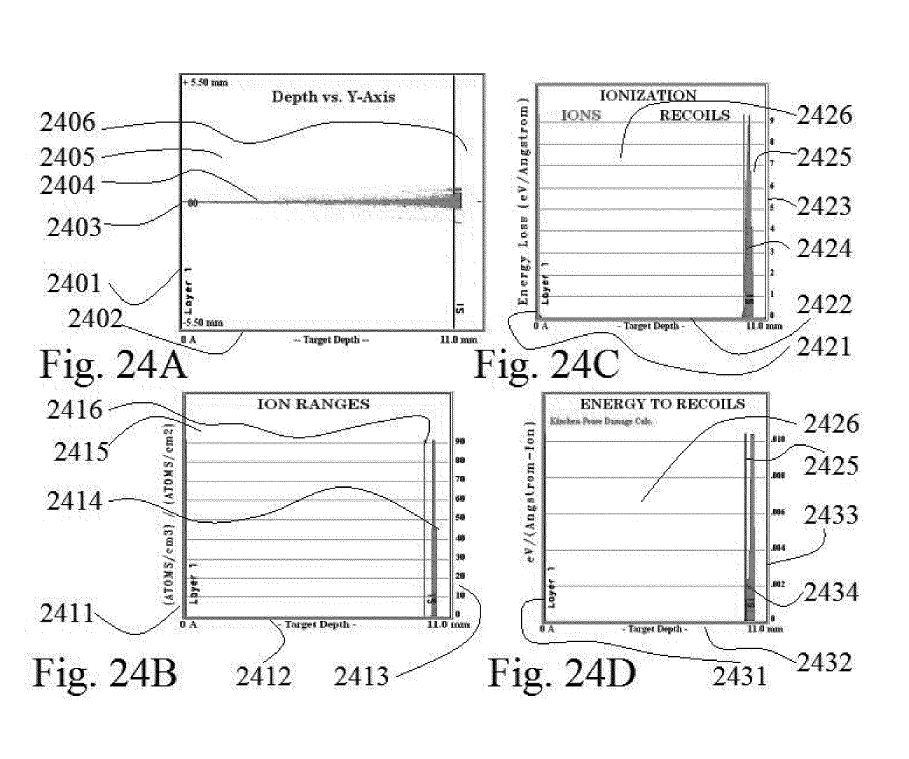

FIG. 24A shows a lateral view of the potential trajectories 2404 the newly created alpha particle 2403 may take in the measurement device that has a 10 mm gap of Deuterium gas in normal conditions 2405 and hits the Si barrier detector 2406, stopping inside. It shows the trajectory length on abscises 2402 and the lateral straggling on ordinate 2401.

FIG. 24B shows the alpha particles ion rande 2414 that stopped in Si detector 2416 after crossing the deuterium filled gap 2415. The particle density is shown on the ordinate 2411 with the scale values on the right ordinate 2413 and the distance traveled on abscises 2412. It is seen a typical case for charged particles that the stopping range 2414 read in abscises 2412 is about the same for all of them. That is an important feature in the device for future gas collection.

FIG. 24C shows the particles power deposition by ionization 2424 and almost no recoils. The energy loss 2421 has the scale plotted 2423 on the right ordinate, and is plotted as function of the traveled distance in materials (the deuterium filled gap 2426 and the Si detector 2425) shown on abscises 2422.

FIG. 24D shows the energy to recoils 2434 plotted on the ordinate 2431 with the values on the right ordinate 2433, with the values in milli-eV, being several orders of magnitude smaller than the ionization energy deposition, as function of the traveled space represented on abscises 2432. The particles traveled through the Deuterium 10 mm long gap 2426 and stopped in Si detector 2425 where most of the recoils have been inflicted.

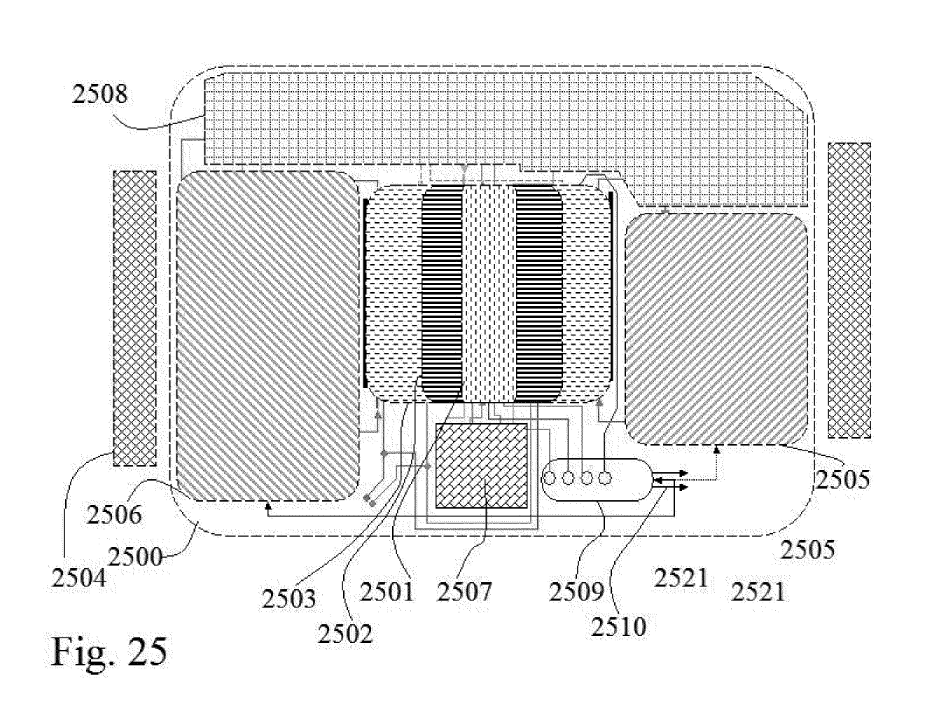

FIG. 25 is a schematic diagram of the power source that relies on nano-cluster controlled nuclear reaction.

The power source is made of an external enclosure 2500, containing the following modules:

The central burner 2501, that contains a “CIci” nano-structure that harvests the recoil energy of the atoms involved in nuclear reaction. In the central burner the combustible fluid that can contain Deuterium, Hydrogen or Tritium is introduced and reacts with the Palladium, Platinum or Nickel atoms in nano-clusters. In this area there are means to control the reaction rate by controlling the input parameters as pressure, temperature, electric field, input and output flows. The central burner is built on a “CIci” structure that converts in electricity the energy of the recoiled nuclei. An important fraction of this will be heat that will be removed from the structure by same liquid flow, carrying the heat outside in a heat exchanger.

The conversion module 2502 that converts the energy of the resulted fusion product in electricity. This module contains the high-energy customized “CIci” structure that converts the energy of alpha particles into electricity. It also uses Helium for its cooling purposes. It may also use actinides in the structure to convert the energy of emitted neutrons by fission and fission energy harvesting.

As a general use the first charged particle energy conversion module may not contain actinides being very thin compared with what is needed to harvest the neutron's energy and amplify it in fission processes.

The second stage of the direct energy converter 2503, that contains “CIci” structures customized for lower energy and terminal structures robust to the end of range damage. These structures will be cooled down by a Helium flow.

To prevent the end of range excessive damage the end structures will have higher porosity and liquid or viscous material trapped in the pores that recover after the end of the range dislocation process. Another alternative solution is to use special cells that fail-safe and may be easily replaced when damaged.

The third energy conversion stage 2504 is placed outside the box, because it has high volume, being about 1 ft thick of nano-structure fulfilled with actinides exhibiting high cross section, and driving to a sub-critical nuclear fission structure.

The burner converter stage is using a special unit 2507 that to inject the fluid and re-circulate them for cooling. It uses for cooling the same combustible fluid because there is not too much room to separate the circuits. The pressure is dynamically established by the differential pumping method.

The main fuel system 2508 that provides the fuel to the burner system and re-circulates it, cooling and purifying it and preparing for being reused. The system supposes no leaks of any material all being content inside the system.

The helium cooling system and helium recovery 2505 and 2506 is a closed system attached to each energy converter structure. It cools the harvesting structure in the zone where it has the maximum conversion efficiency and prevents overheating. It also recovers the reaction-generated helium and prevents its agglomeration in the structure where it may trigger damaging effects.

The control system and power extraction 2009 combines the power extraction systems and power adjustment for delivery with control system, integrating the feed-back signals coming from all the modules 2510, with those from the external control unit.

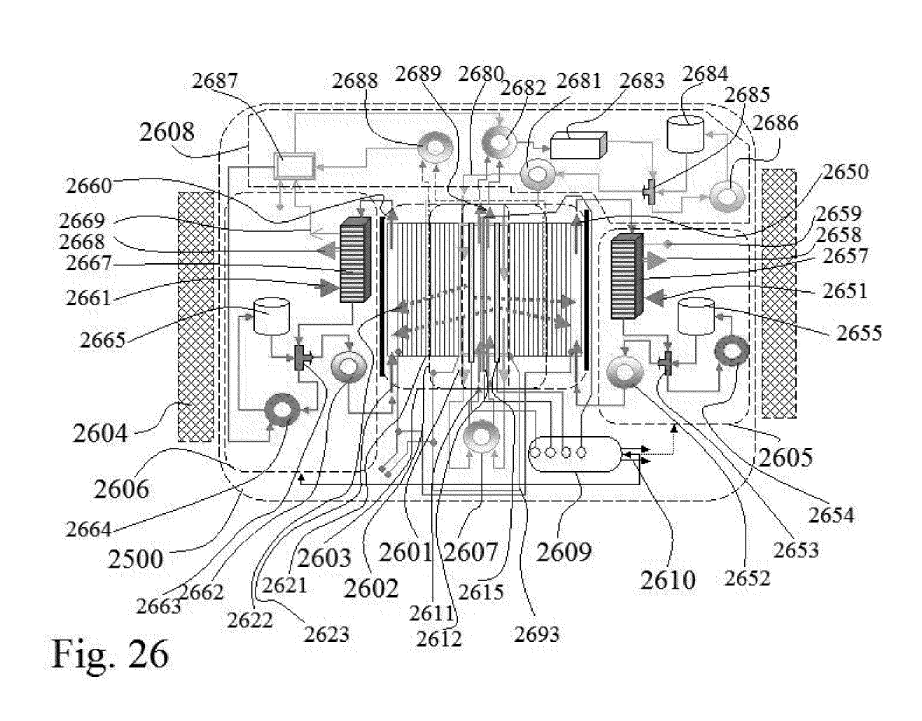

FIG. 26 shows a more detailed view of all the subassemblies that are integrated in the functional modules, that are easy plug-ins having standardized connection arrays made with the purpose that everything to be interchangeable and allow an easy maintenance.

The outer case 2600 is integrating in the same box the modules needed that the harvesting unit to operate for transmutation and aneutronic fusion processes. It allows the connection on exterior side of the special harvesting modules 2604 used for neutronic fusion that is coming with their own shield, and structure.

This structure is bulky and heavy and it comes as a modular nuclear fission reactor subcritical structure that integrates in its core the entire fusion box 2500 or only its active part 2603, leaving the rest of equipment out of the radiation field.

The central part of the structure is the active element box 2603 that contains inside the burner 2601 where the nuclear reaction takes place blanketed on its lateral sides by the energy harvesting modules 2602. The structure may have a cylindrical or rectangular geometry. In case of cylindrical geometry the harvesting modules will be built and add as sectors. In fact all the dimensions we are talking about for the inner structure 2603 are about 1 mm diameter and up to 100 mm long, while for planar structures they are up to 50 mm lateral and 100 microns thick. A bigger interlaced structure being the most preferred. The present figure shows the simplest configuration for the power source.

The central module also called burner 2601 is made of a very thin containment structure that is mainly a frame. It contains the fittings 2611 that assure the fuel re-circulation from inside to the re-circulation module 2607 and back into the burner. The arrows show the flow of fluid through the system. The central armature 2612 is used for electric polarization, applying an electric field with role of ion implanter in the burner structure 2615 that is made of a foil or a micromesh supporting the active material plated structure.

The foil has the capability of warming up electrically as a resistor and also operates as a grid in connection with the central armature 2612. The fuel fluid is washing the structure inside on all directions and is caring out the heat, while is taking part in the reaction. From the burner structure also a set of electric wires are connected to the control unit 2609. The structures 2607 is basically show a MEMS fluid multi-stage pump.

The main wires coming from the burner are related to resistor 2615 power warm-up and its temperature control, central armature 2612 to active mesh 2615 voltage, central armature temperature, burner harvesting structure current output, and flow detection.

The burner modularity and interchangeability is important because it is the most stressed structure from all the system.

The fluid coming into the burner is accelerated between armatures and penetrates the microstructure deposited on a lateral grid in the “C” elements of the associated “CIci” nano-beaded structure. The electron avalanches that creates an electric current and voltage is further transmitted outside the structure to the control module 2609 where it gets a multiple use, as information about the reaction rate and output energy.

The complementary particle associated with the ternary nuclear reaction 2622 is crossing the burner structure and stops in the “CIci” harvesting structure 2621.

The structure is also modular, having various modules stacked together but being customized for different zones of the particle's stopping range where it exhibits different energies. A helium flow 2623 cools the structure and maintains it inside the operational domain that exits the structure collecting and the nuclear reaction produced atoms.

A very important part that assures the operation of the harvesting structure is the cooling system that relies on the use of Helium gas (other fluids may be used too) that is pumped inside by the MEMS pump 2662. The gas flows in the structure channels mainly between modules and collects the heat and all the residual gases formed inside, maintaining the operation pressure inside.

The exhausted gas 2650,2660 is driven into a heat exchanger 2657, 2667 that took outside air 2651, 2661 to cool down, and exhausts it 2658, 2668. The heat exchanger unit also separates and collects the fuel fluid 2659, 2669 and sends it back to feed unit.

The cooling gas that leaves the heat exchanger is going into a multistage two way flow switch 2653, 2663 that can resend it back into the recirculation pump 2652, 2662 or may direct it into a compressor pump 2654, 2664 that pushes it back into the tank 2655, 2665. All these are micro-fluidics devices controlled from the control unit 2609. For good operation there are needed two cooling system for a lamellar structure, one for each harvesting module.

The units 2605 and 2606 are identical but serving different energy conversion “CIci” units.

The fuel control circuit uses a storage tank, 2684 that can be placed outside the structure or inside, because the consumption is very small connected through a multi-stage, multi-way flow micro-switch to the recirculation pump 2681 that introduces the fuel into the burner 2680 on the active structure side 2615.

From here it passes in the opposite recirculation pump 2607 that reintroduces the flow in the center of the cell, from where it exits the structure 2689 and is taken by a multi-stage pump 2682 that passes through the heat exchanger 2683 and further in the flow micro-switch 2685 that may direct it back in the circuit or into the compressor micro-pump 2686 and store in the tank 2684.

Some of the fuel may diffuse through the harvesting structure 2621 from where is directed collected by the vacuum pump 2688 that sends it into a purifier structure 2687, together with the fuel recovered from the cooling circuit 2605 and 2606, respectively 2669. From the purifier 2687 the fuel is redirected back to the circuit 2682, while the coolant is sent to coolant recirculation pump 2664.

The control unit 2609 collects the signals from all the units and bring them into a computer data acquisition system, interprets them in real time and sends commands to all the elements of the systems as micro-pumps drivers, micro-switches, voltage and current controllers. The harvested energy collected on the wires 2693 from the energy converter modules and that collected from the burner's embedded direct energy collection structure is processed by the controller specialized unit in order to be delivered outside the structure with the appropriate voltage and current.

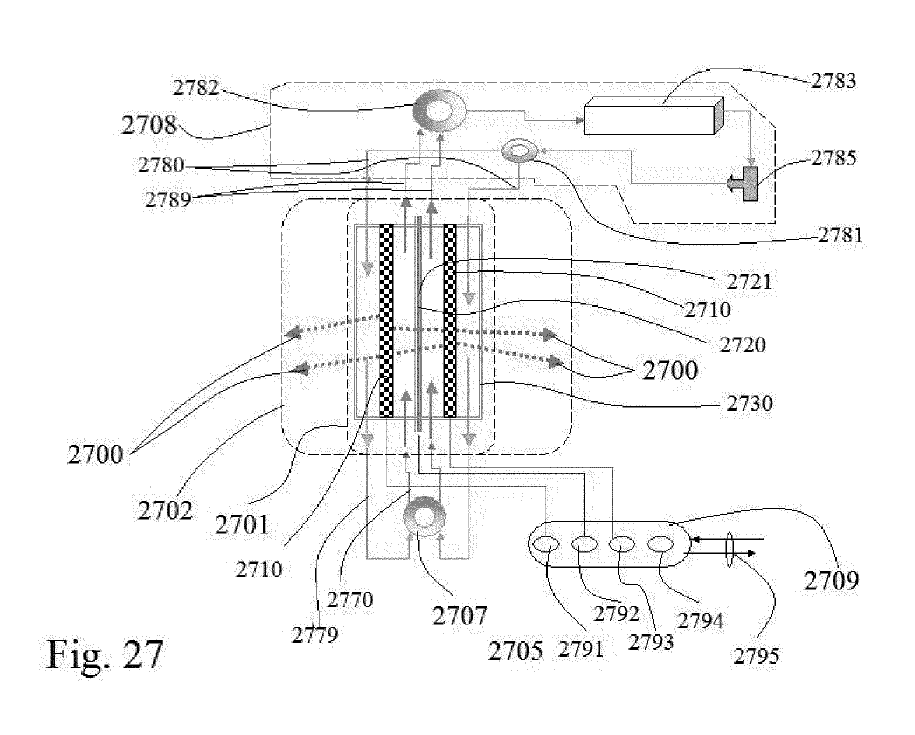

FIG. 27 shows some details in the burner structure in a schematic diagram. As previously shown the burner system has a fuel supply module 2708, that most commonly is a tank placed outside the system and a heat exchanger, 2783 of deuterium or hydrogen that uses a set of valves 2785 and MEMS pumps 2782, 2781 to deliver the right amount at the right pressure and input temperature. There are several input 2780 and output 2781 fittings coupling to the burner's module 2701.

The burner module 2701 on the other side has another MEMS pumps 2707 that sucks the fuel from the burner 2779 and reintroduces in the center 2770 using customized fittings. The control unit 2709 controls the pumps driver in such a manner that through the differential pumping to assure a good flow inside and the right static and dynamic pressures and temperatures.

The burner 2701 has a customized modular structure allowing it to tightly couple with the converter module 2702. If the transmutation reaction is mainly used such a (H,Ni)→Cu, that generates in initial stage a Cu and a Ni recoil sharing several hundred keV the mass defect energy, there is no need for the direct conversion modules 2701 to blanket the burner 2701 all the released energy will be converter inside the burner structure in electricity and heat. If the fusion reactions are used a H, D, T or alpha particle will result being accompanied by a neutron only in neutronic fusion schemes. In all these situations the presence of the direct energy conversion module 2702 to blanket the burner 2701 is recommended.

The burner 2701 has the fuel come in from the supply module 2708 through the fittings 2780 is washing the burner structure interacting with the nuclear reaction facilitator material stored on the direct energy conversion hetero nano-structures 2710, warms up and is extracted thru the fittings 2779, reprocessed and reintroduced in the center through the fittings 2770. Inside the fuel fluid acts as coolant, and is exhausted through the fittings 2789 back into the supply unit's 2708 pump 2782 that compresses it and sends to be purified, cooled down in the heat exchanger 2783 and reused.

Inside the burner 2701 nano-structure the fuel is heated by the micro grid 2720 and accelerated towards the nano-structure 2710 by an electric field created by the controller 2709 applied between the plots 2792 and 2791, 2793.

The plot 2794 is used to collect the temperature, pressure data, and all the information is transmitted outside to a data acquisition and process control unit via the bus 2795.

On the burner nano-structure support, there is a “CIci” structure created, using for the “C” the material of the facilitator, or an alloy of a high electron density material with the facilitator material on the surface.

Because the released energy of the recoiled facilitator are relatively small of the order of few hundreds keV, the total length of the facilitator structure is in the order of about 1-2 microns thick. This dimension is a compromise between the acceptable mass of facilitator and acceptable surface for power extraction. The usage of the carbon nano-foils contributes to the process heat extraction by it's high heat conduction coefficient.

The average thickness of the burner stage is about 3-5 microns and being connected to fittings that seals it from the other stages of the converter.

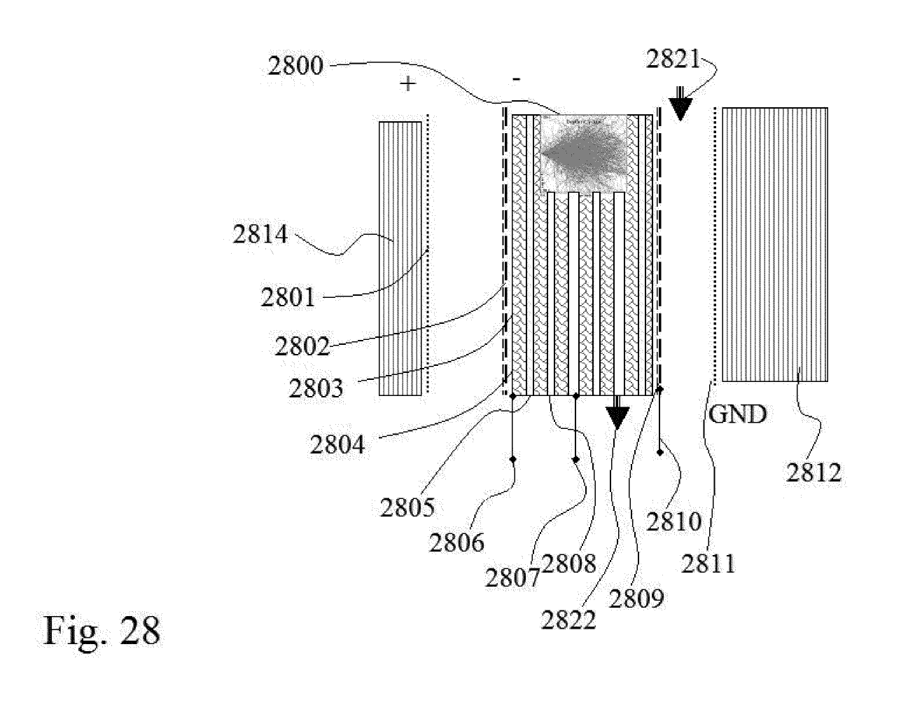

FIG. 28 shows a detail inside the burner's nano-structure. The goal of this structure is to harvest the energy of the recoiled facilitator nuclei at the end of the entangled nuclear reaction. The facilitator material is Ni, Pd, Pt, W, Au etc. structured in nano-clusters of low order under 10 k, having the dimensions under 7 nm. When a recoil happens, the resulted nucleus, say Cu, travels with an energy of about 300 keV inside the Ni lattice, where a Ni counterpart shares about 400 keV of trahectories shown in the overlapped picture 2800, presented in detail in FIG. 23E.

The fuel 2821 enters the structure from the lateral side, and diffuses all over inside agglomerating inside the facilitator nano-structure. When the temperature in the nano-cluster and the electric field and fuel pressure outside the resonant mode builds-up and the nuclear reaction cross section increases. The fuel taking a part of the reaction heat exits the structure 2822 and is further reprocessed and reused.

The burner converter nano-structure is made of an external foil 2809 2802 that contains the nano-hetero structured pack. These foils are permeable leaving the fuel pass through and diffuse inside the nano-structure.

The next layer 2803 is a inherit “CIci” structure that does not contains facilitator material but acting as symmetric and of range in a bi-directional elemental cell.

A conductor 2804 that forms one plot of the power harvesting connected to the outside plot 2806 follows it. The other pole 2807 is connected to the opposite polarity layers.

The next “CIci” structure 2805 contains facilitator material structured in nano-wires or nano-clusters embedded on nano-tubes surface or facilitator coated nano-foils. This structure is repeated as many times as needed inside the burner core until all the energy is converted in electricity.

The “CIci” converting structures with facilitator embedded are structured in modules, separated by gaps with role in fuel circulation and accelerated diffusion 2808. The pole 2810 is used in connection with the pole 2806 to apply a heating current on the structure to reach the reaction optimal temperature and after started to maintain it. The V/I ratio is giving the resistance of the grid that warms the structure and that is temperature dependent being used to give an indication on the average temperature. The fuel flow is structured in such a manner as to minimize all the local abetments from the average temperature and keep the reaction homogenous in the facilitator volume.

As was clear stated before, the transmutation reaction energy is only a particular case of application of the structure. The main goal is to use the facilitator for deuterium aneutronic fusion that releases a 22.4 MeV from which the alpha particle takes about 95%, and the recoiled facilitator (Pd, Ni,Pt in this case) gets up to 300 keV. It is a tremendous need to harvest the energy of the alpha particle with maximum efficiency and that is why the lateral harvesting structures 2812, 2814 are added. The direct energy converters are attached to a separation nano-foil acting like a grid 2801 and 2811 connected to the local ground. The power generation in these “CIci” facilitator free device is taking place as previously described.

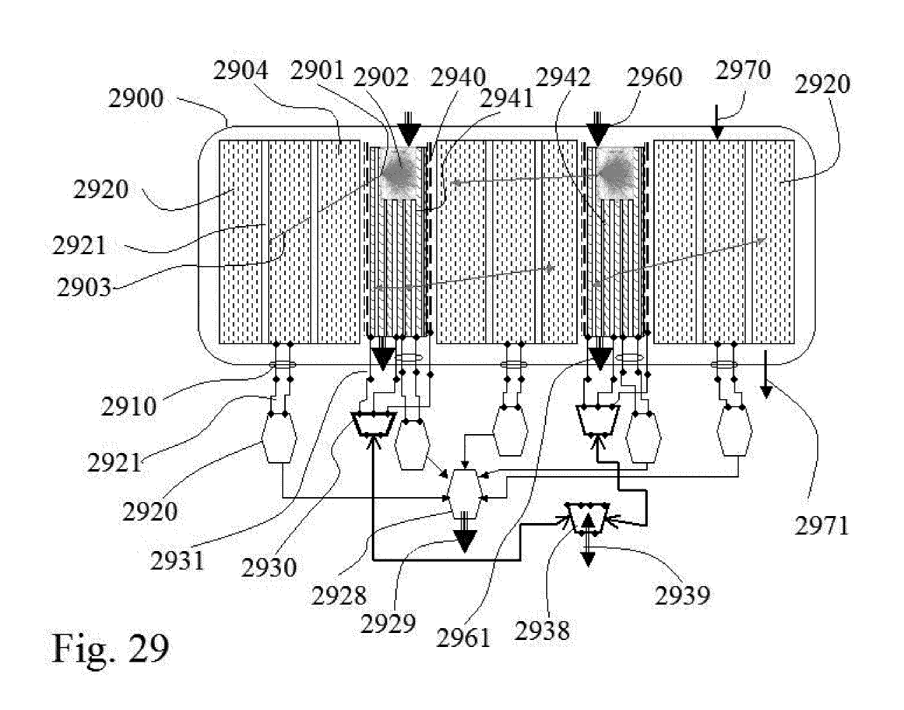

FIG. 29 shows an interlaced setup of a conversion module 2900 that uses two burner cells and 3 conversion cells as an example of mixing the burner structure into the conversion structure in order to maximize the power density. The lower limit is given in FIG. 28 where a single burner unit (a direct conversion cell including the facilitator on one of its elements “C”, “c”, or “Ii”) is surrounded by a single direct conversion cell (where its materials do NOT contain facilitator material or structure, is like a plating harvesting the energy of particles coming from outside). Another way is to grow the dimensions of the burner in FIG. 28 up to 95% or more from the dimensions of the harvesting unit. That will drive to the following dimensional calculation: knowing that the inert (not containing facilitator material) cell dimensions are about 50 microns, and the total dimension is 100 microns, that represents 1/20 of the cell dimension that will be 2 mm ( 1/10″) thick, and being able to deliver up to 1 kW/cm², at the maximum of the resonance. That will take about 6 nm.liters of Deuterium gas per year to continuously operate, if no radiation or structural damage occurs.

The energy conversion cell case 2900 is surrounding the nano-structure, and contains all the necessary fittings for fuel input 2960 and output 2961 in the burner as well the additional cooling agent 2970 and respectively the exit 2971.

The burner direct conversion nano-structures are marked by showing the lateral view of the possible paths inside that lattice of a recoiled facilitator nucleus 2902, if the reaction point is that marked 2901. The complementary fusion product path 2903 is longer because its kinetic energy is bigger.

This path crosses the normal harvesting structures 2920 that are grouped in sub modules separated by cooling interstices 2921 where a He flow is passing between the fixtures 2970 and 2971.

The near burner, normal direct conversion module 2904 has the surface customized to fit tight to the burner surface 2940 in order to contain the fuel flow inside the burner's direct conversion structure 2941 and between the specialized input 2960 and output 2961 fittings. For flow optimization reasons the burner contains interstices 2942 that facilitates the residual heat extraction.

The harvested electricity is collected at each module's plots 2910, and via specialized cords 2921 is driven to a local dc-converter 2920, that prepares the voltage to be summated in a summator-converter module 2928 and extracted 2929.

The local control units 2930 are connected to the process by specialized terminals and connections 2931, each burner module having a dedicated controller. All the controller signals are accumulated in a higher level controller 2938 that communicates via a bus 2939 with the external controller, that can be a computer or a dedicated unit.

These features of repetitive structure makes it easy scalable and redundant easy to be customized.

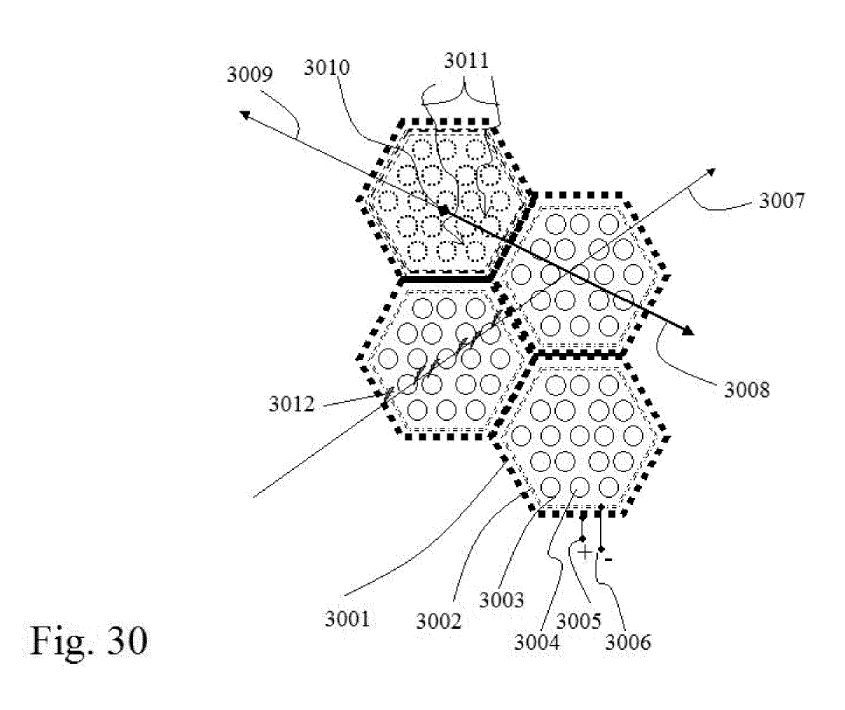

FIG. 30 is showing another version of the generic “CIci” meta-material, realized in a mixed hexagonal structure used to harvest the energy both of the transmutation product and the fusion product resulted from the nuclear reaction between the fuel (a light isotope) and facilitator (a higher mass isotope) embedded in the nano-structure.

The hexagonal structure 3001 is made of a “C” material, and may include the facilitator material (Ni, Ti, Pd, Pt, etc.) coating in a nano-structured delta-layer. In this way it will be exposed to the nuclear fuel, 3011, a light isotope (H, D, T, ³He, B, etc.) that together with the facilitator generates a nuclear reaction when the nano-cluster-nuclear entanglement conditions are met.

The hexagonal structure external surface 3001 is coated in a “C” or “C″+”F″ (F stands for facilitator) material, is porous allowing nuclear fuel 3011 pass through. On inside it is coated by an insulator “I”, and may have a delta layer applied between, then another delta layer is applied to support the “c” layer 3002 that may also hold nano-clustered facilitator as a delta layer or in the alloy. The inside of the hexagonal structure is made of a porous insulating material 3003, that may be aero-ger, ceramics, etc., that depending on facilitator material type may contain it in the structure. In the porous insulator 3003 some “C” material nano-beads 3004 are floating. These nano-beads may be coated in the facilitator material “F” 3010, in order to expose it as much as possible to the nuclear fuel “NF” 3011 diffusing through the structure.

The exterior coatings with “C” porous layer 3001 is connected to the positive electric pole 3005, while the “c” layer 3002 is connected to the negative pole 3006. Due to the dimensions of the structure in tens of nm the expected voltages are in Volt domain, and serial parallel connections of the cells inside is required, in order to deliver higher voltages.

When the entanglement resonance conditions are met, in a position in the structure 3010 the reaction takes place and may have as products a recoiled medium mass nucleus 3008 that is usually a facilitator atom, and a by product that may be a facilitator transmutation or a fusion product 3009 that flies in opposite directions through the lattice. If the product is a fusion product 3007 it has a much longer range, about 30-50 microns than a transmutation product that usually drifts up to 100-200 nm.

It is desirable that the lattice to be light, porous and harvest the energies of both the transmutation 3008 and fusion products 3007. That makes necessary that on the reaction cell borders to have a zone without facilitator added to the structure, in order to assure the containment and energy harvesting of all the generated byproducts inside the direct conversion structure.

While the invention has been described in detail with reference to specific embodiments thereof, it will be apparent to those skilled in the art that various changes and modifications can be made, and equivalents employed, without departing from the scope of the appended claims.

What is claimed is:

1. A method to produce energy and means to control energy production that uses the quantum nuclear entanglement stimulated inside the nano-structures by the eigen-vibration modes to initiate nuclear reactions and control the reaction rate by controlling the parameters of the nuclear fuel (hydrogen's isotopes) fluid affinity for the materials contained in the nano-structure, called nuclear reactor facilitators isotopic enriched and selected by reaction probability by:
adjusting the temperature that controls the lattice vibration modes amplitudes,
electric field that controls the fuel's atoms implantation depth and diffusion rate, and
partial pressures of the reaction species, (various hydrogen isotopes, helium and other fluids used as reaction moderators).

2. A method to produce electric energy according claim 1, using nuclear reactions generated by stimulated quantum entanglement in nano-structures that consists in:
a nuclear reaction facilitator made of a nano-structured micro-layer of a isotopic enriched material with high affinity for the nuclear fuel that can be at least one species of hydrogen isotopes or other light isotope drifting in that nano-structure, called facilitator,
means of control of the nuclear reaction made of: temperature adjustment, electric field and partial isotopic pressure adjustment
a moderator material that participates with the fuel in the nuclear reaction determining the reaction nuclear channels and the rates.
An assembly of nano-hetero-structures, layers, beads, loaded nano-tubes or coated nano-wires electrically connected forming a super-capacitor that loads from the kinetic energy of the nuclear reaction products and discharges the accumulated energy as electricity.
An electronic control system that regulates the parameters of the produced electricity and the functional parameters of ingredients in the reaction structure.

3. A device to produce electric energy using isotopic nano-structures called facilitator, to control the nuclear entanglement and facilitate ternary nuclear reaction as fusion and transmutation between a light isotope agent that interacts with one or two facilitator nuclei located in the nano-cluster structure, by controlling the temperature, electric field, pressure of the system made of:
a nuclear reaction facilitator module made of a plurality of microfoils containing a support as a carbon foil or metallic foil on which the nano-structure of the facilitator material is deposited containing materials as Ni, Pd, Pt, that forms high hydrides.
A coating nano-layer with the role of stabilizing the facilitator material nanostructure.
A nuclear reaction rate control assembly made of an enclosure chamber created by the conversion
A nuclear reaction enclosure that contains inside facilitator material and control system and has input and output fittings/orifices for the fuel fluid and additional reaction control to flow in and out the enclosure with a controlled pressure.
A resistive grid placed in the center that adjusts the temperature electric field of implantation and polarization
A fuel moderator with controlled partial pressures
Temperature made of a resistive electrode that is wormed up by a current passing along it and by a current passing along the metallic support micro-foils of the facilitator having as control parameter its own resistance with temperature variation of electric field by applied voltage on the facilitator foils and the central electrode grid versus the enclosure outer walls
The partial pressure is adjusted by the flow's dynamic control using a differential pumping through the input and output orifices in the nuclear reaction chamber.
Fuels (H,D,T gas or liquid) feeders device made of a fresh fuel reservoir pump and control valves and buffer tank
Moderator fluid device made of a reservoir tank of fresh moderator, pump and flow control valves recuperating system and buffer tank
Fuel recuperation system made of an exhaust pump, flow control assembly, temperature adjustment assembly (heat exchanger) recuperator/separator that separates the fuel from moderator, pumps for pressurization to store in the buffer tank, measurement device, (p, T), composition
Direct conversion of nuclear reaction energy into electricity system made of:
high energy assembly
diffused fuel recuperation
mid energy conversion assembly
cooling assembly
final energy convertor
byproduct recuperator
electric (I,V) processing assembly
Cooling system that is made of an assembly to exhaust heat heat from inside structure by a micro-flow of fluid (water, He, etc)
exhaust pipe
heat exchanger
chemical separator/recuperator
recirculation pump
tank
external coolant flow
Power control unit—that has a micro-controller that analyses the measurements makes prediction calculations and transfers command to actuators making feedback differential measurements and adjustments.

4. A direct nuclear energy conversion structure, called “DNECSC” (Direct nuclear energy conversion super-capacitor) according the claim 3 made of a plurality of conversion modules, each module being made of a plurality of elementary conversion cells,

5. A direct conversion of nuclear kinetic energy of the moving particles into electricity according the claim 4 whose internal elementary energy harvesting cell, generically called “CIci”, structure is made of:
a high electron availability electric conductor material, called “C” that usually is a conductor material having high electron density and low extraction work, shaped as a nano-layer, forming the positive armature of the super-capacitor DNECSC, followed by
an interface material deposition, generically called “δ” (delta) layer, or “CδI” having a thickness of several atomic layers, that enhances the electronic properties of the “C” layer and stabilizes the structure for the next layer
a insulation layer “I” with the thickness in the range of the ballistic flight of the electrons showers created by the knock-on electrons generated by the moving particle that are tunneling this layer and are stopped in the adjacent armature, with the surface enhanced by
an interface delta layer “Iδc” that creates local magnetic moments in order increase the effective insulation resistance and breakdown voltage and to turn the electron shower along the surface of the next layer,
a low electron availability electricity conductor material “c” that stops the electron shower coming from the layer “C” and emits a very small shower along the moving primary nuclear particle direction forming the negative armature, whose surface is coated by
an interface delta layer “cdi” that creates local magnetic moments in order increase the effective insulation resistance and breakdown voltage and to turn back the electron shower into the “c” layer, and stabilizes the nest layer
an insulator “i” of the elementary cell and the last armature, assuring high breakdown voltage and low power deposition from the primary particle, ending the elementary nuclear energy harvesting cell.
where the “C” and “c” armatures are connected to electric connecting plots, and
where the cells may be connected in combinations of series and parallel to deliver customized electric power

6. A direct conversion of nuclear kinetic energy of the moving particles into electricity according the claim 4 whose internal elementary energy harvesting module structure is made of:
a positive armature made of an high electron availability electricity conductor material material “C”, that generates an electron shower after the interaction with the primary moving nuclear particle, covered in
a interface layer called “CδI” delta layer stabilizing the surface versus
a open porous insulator layer “I” having the thickness lower that ¼ of the range of the primary nuclear particle in that material, and
having a suspension of nano-beads made of a high electron availability material that may capture and reemit electron showers along the direction of the primary nuclear particle
followed by an interface “Iδc” delta layer that stabilizes the structure towards a
low electron availability electricity conductor material “c” that serves as the negative armature terminating the harvesting module.
where the “C” and “c” armatures are connected to electric connecting plots.

7. A direct conversion of nuclear kinetic energy of the moving particles into electricity according the claim 4 whose internal elementary energy harvesting module structure is made of:
a positive armature made of an high electron availability electricity conductor material “C”, that generates an electron shower after the interaction with the primary moving nuclear particle, covered in
a interface insulator layer stabilizing the surface versus
a porous conductor electrolyte “c” having the thickness lower that ¼ of the range of the primary nuclear particle in that material, and
having a plurality of nano-tubes loaded with a conductor material “C” or coated in dielectric nano-wires made of the conductor material “C”,
the electrolyte being sealed between two “c” armatures that polarizes negatively.
where the “C” and “c” armatures are connected to electric connecting plots.

8. A direct conversion of nuclear kinetic energy of the moving particles into electricity according the claim 4 whose internal elementary energy harvesting module structure contains facilitator material and has a porous structure that to allow fuel that can be H,D,T or their oxides diffuse towards the facilitator that can be Ni, Pd, Pt, Th and generate the nuclear reaction.

9. A direct conversion of nuclear kinetic energy of the moving particles into electricity according the claim 4 whose internal elementary energy harvesting module structure contains interstices for cooling and reaction byproducts recovery.

10. A direct conversion of nuclear kinetic energy of the moving particles into electricity according the claim 4 whose internal elementary energy harvesting cell structure contains actinide material that converts and amplifies the fusion neutron energy by absorption into a fissile actinide and fission or absorption into a fertile actinide followed by transmutation into a fissile actinide, forming a subcritical structure surrounding the fusion elements.

11. A direct energy conversion device according to claim 3 made inside a modular structure, containing at the center the nuclear transmutation direct energy conversion modules that harvests the energy of recoiled facilitator nucleus or transmuted facilitator nucleus, surrounded by a set of direct conversion energy sub-modules, each customized on the energy domain it has to harvest, and with interstices for coolant agent to carry out the residual heat, sealed into a case, and surrounded by the functional modules as heat exchangers, fuel supply, byproducts recuperators and the integrated control unit with power output.

12. A direct energy conversion device according to claim 3 made inside a modular structure, where the direct energy conversion structure containing facilitator material forms a module spanning over the stopping range of the recoiled transmuted facilitator nucleus and has the fuel circulating in opposite directions.

13. A direct energy conversion device according to claim 3 made inside a modular structure, where the direct energy conversion structure containing facilitator material forms a module spanning over the stopping range of the recoiled transmuted facilitator nucleus but no more than two stopping ranges being bordered by direct energy conversion modules free of facilitator making a repetitive structure.

14. A direct energy conversion device according to claim 3 made inside a modular structure, where the direct energy conversion structure containing facilitator material forms a module spanning over many stopping range of the recoiled transmuted facilitator nucleus representing the majority of the conversion module being bordered by conversion modules for the fusion product harvesting free of facilitator material inside.

15. A direct energy conversion device according to claim 3 made inside a modular structure, where the direct energy conversion structure containing facilitator material forms a module spanning over the stopping range of the recoiled transmuted facilitator nucleus and alternates with the direct energy conversion modules that harvest the fusion product charged particle, spanning all over the structure and being terminated at borders with fusion product energy harvesting only modules..

16. A direct conversion of nuclear kinetic energy of the moving particles into electricity according the claim 5 whose internal elementary energy harvesting module structure is made of an sequence of “ciClciClc” where the letter has the meaning described in claim 7 and has the capability of harvesting the energy of the particles coming from both directions perpendicular on the layer surface.

17. A direct conversion of nuclear kinetic energy of the moving particles into electricity according the claim 6 whose internal elementary energy harvesting module structure is made of an hexagonal structure coated with “C” and “c” armature material and containing inside a porous insulator that supports the “C” nano-beads and has the capability of harvesting the energy of the particles coming from all directions.
